(19) United States
(12) Patent Application Publication
(10) Pub. No.: US 2025/0098648 A1
(43) Pub. Date: Mar. 27, 2025

(54) SUB-SURFACE MULTI-STAGE OXYGENATION SYSTEM SUPPORTING NET PEN AQUACULTURE

(71) Applicant: INNOVASEA, Boston, MA (US)

(72) Inventor: Barnaby Jude WATTEN, Winchester, VA (US)

(73) Assignee: INNOVASEA, Boston, MA (US)

(21) Appl. No.: 18/836,480

(22) PCT Filed: Feb. 6, 2023
(86) PCT No.: PCT/US2023/012377

§ 371 Date: Aug. 7, 2024

Related U.S. Application Data
(60) Provisional application No. 63/308,742, filed on Feb. 10, 2022.

(51) Int. Cl. A01K 61/60; A01K 61/10; A01K 63/04

(52) U.S. Cl. CPC A01K 61/60; A01K 61/10; A01K 63/042

(57) ABSTRACT

A multi-stage oxygenator includes a submerged fluid-tight pressure vessel that has first, second, and third sections. A baffle divides the second section into compartments, and a water delivery mechanism delivers water into the second section via the first section. An interface between the first and second sections delivers water to the compartments as water jets or droplets, creating flooded zones. A gas delivery mechanism delivers oxygenated gas into a compartment to create a gas void, through which the water jets or droplets fall, between its flooded zone and the first section. A gas connection through the baffle allows gas from the compartment to create another gas void in a subsequent compartment in series therewith. A gas release device maintains the gas voids by releasing gas from a last compartment. The third section connects the compartments allowing water from their flooded zones to mix to produce treated water that is outputted.

### CROSS-REFERENCE TO RELATED APPLICATIONS

This application is related to and claims the benefit of priority to U.S. Application No. 63/308,742, entitled “SUB-SURFACE MULTI-STAGE OXYGENATION SUPPORTING NET PEN AQUACULTURE” and filed Feb. 10, 2022, the entire contents of which are incorporated herein by reference.

### BACKGROUND

The aquaculture industry is growing rapidly in response to a worldwide demand for seafood that exceeds supplies provided by natural fish stocks. Intensification of production methods, such as net pen technology, is attractive given its reduced dependence on fresh water resources. Production capacity is restricted, most often, by a limiting supply of dissolved oxygen (DO, mg/l), as well as accumulation of fish metabolites including dissolved carbon dioxide (DC, mg/l). Water quality limitations are correlated with inadequate water exchange during periods of increasing biomass or stress during disease treatment and harvesting operations. DO supplementation can be achieved by contacting water with an oxygen enriched gas within equipment designed to provide large gas-liquid interfacial areas. These systems offer the unique ability of super-saturating water with DO, significantly reducing the volume of water that must be treated to satisfy a given oxygen demand. Reductions in water flow rate, in turn, lower production costs by minimizing energy and capital inputs related to oxygenation. Unlike air contact systems, oxygen absorption equipment provides for dissolved nitrogen (DN, mg/l) stripping below saturation levels for purposes of controlling gas bubble disease. The extent of DN stripping or DO absorption is easily regulated by adjusting gas flow and/or system operating pressure. This flexibility in performance provides additional savings in water treatment costs. Commercial oxygen purchased in bulk liquid or produced on site with pressure swing absorption equipment has significant value. Thus, the design of oxygenation equipment must provide high oxygen utilization efficiency (AE, %) with reasonable energy input (TE, kg O₂/kWhr). Furthermore, as oxygenation equipment is used in fish culture in a life support role, the designs employed must reduce risk of electrical or mechanical failure. This is important as technology advances in enclosed and semi-enclosed fish pens to help reduce the intake of near surface water into the fish living space increases the challenges for oxygen management. Thus, there is a need for an efficient oxygenation system applicable to enclosed and semi-enclosed fish pen systems that maximizes the benefit of intake water flow.

Furthermore, the high solubility of carbon dioxide precludes significant desorption within commercial oxygen absorption equipment. This characteristic has limited application of commercial oxygen absorption equipment in aquaculture despite the ability of such equipment to increase allowable fish loading rates. DC is typically removed by air stripping, given the need for application of very high gas to liquid ratios. Forced air exchange in such air stripping systems requires significant energy input for both air compression and humidity, and temperature and carbon dioxide control within enclosed aquaculture facilities. Energy is also needed for a separate pumping requirement and/or development of additional gas-liquid interfacial areas required for gas transfer.

Common systems/methods for oxygenation and/or DC stripping in aquaculture include the U-tube, down flow bubble contactor, side stream oxygen injection, enclosed spray tower, enclosed pack column, enclosed surface agitation, packing free (standard) multi-stage low head oxygenator (LHO), addition of base reagents, and diffused oxygenation, which all have unique issues that limit their application in aquaculture. These include sensitivity to biofouling (e.g. packed column), excessive maintenance requirements (e.g., diffused oxygenation), increased energy requirements (e.g. surface agitators), high pumping costs (e.g., side-stream oxygenation), limited increases in the change in DO across the system (e.g., LHO), rises in pH levels (e.g. addition of base reagents), and a capital cost requirement that is dependent on local geology related to, for example, the need for deep boreholes (e.g., u-tube oxygenation).

DC usually must be considered in the design of intensive culture systems given increased fish and microbial respiration rates, as well as the need to keep DC below criteria established to prevent stress, nephrocalcinosis, and hypoxia. As previously described, desorption of DC within commercial oxygen absorption equipment is severely limited given the high solubility of this gas species and the use, by necessity, of oxygen feed rates that represent just 0.5 to 3% of water feed rates. DC is typically removed in an independent treatment step by air stripping. This process requires a significant energy input for forced air movement, air heating in cold climates, and water pumping. Further, this air stripping drives DN towards air saturation concentrations that, in recirculating aquaculture system (RAS), forces use of absorber operating conditions that increase the cost of oxygenation. In other words, as DN rises, AE decreases.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

In an embodiment, a sub-surface multi-stage oxygenator system includes one or more chambers, configured to be submerged in or near an aquaculture system enclosure, each of the one or more chambers having an open top. The system also includes one or more distribution mechanisms, each distribution mechanism disposed over the open top of a corresponding chamber of the one or more chambers and configured to distribute liquid provided to the one or more distribution mechanisms in jets or droplets into the one or more chambers. The system further includes a gas input into each of the one or more chambers, the gas input configured to introduce gas into the respective chamber, and a gas output from each of the one or more chambers, the gas output configured to release the gas out of the respective chamber. The jets or droplets enter a liquid held within each of the one or more chambers at one or more regions disposed directly below the one or more distribution mechanisms, to create one or more circulation cells of bubbles.

In an embodiment, a method of performing high efficiency oxygenation uses a sub-surface multi-stage oxygenator system including one or more chambers configured to be submerged in or near aquaculture system enclosure, one or more distribution mechanisms disposed over one or more corresponding chambers, and a gas input into each of the one or more chambers. The method includes providing a liquid to the one or more distribution mechanisms, such that the liquid is distributed in jets into the one or more chambers, and providing a gas through the gas input to each of the one or more chambers, causing the gas to flow through a head-space portion of each of the one or more chambers, above a liquid stored in the one or more chambers. The jets come in contact with the gas in the head-space portion of the respective chamber and then enter the liquid held within the respective chamber to create one or more circulation cells of bubbles in the liquid held within the respective chamber.

In an exemplary embodiment, a multi-stage oxygenator system includes a fluid-tight pressure vessel for use in the submerged state, and which includes a first section, a second section, and a third section. At least one baffle divides the second section of the pressure vessel into two or more compartments. A water delivery mechanism delivers water into the second section of the pressure vessel via the first section of the pressure vessel. The first section of the pressure vessel includes an interface between the first section of the pressure vessel and the second section of the pressure vessel. The interface delivers the water to the two or more compartments in the second section of the pressure vessel as water jets or water droplets to create flooded zones in the two or more compartments. The flooded zones are filled with the water. A gas delivery mechanism delivers a gas into a first of the two or more compartments to create a first gas void in the first of the two or more compartments. The gas includes oxygen. The first gas void is disposed between the first section of the pressure vessel and a flooded zone of the first of the two or more compartments, and the water jets or water droplets fall through the first gas void to a first free surface of the flooded zone of the first of the two or more compartments. A gas connection through the at least one baffle allows gas to move from at least the first of said compartments to a at least a second subsequent compartment in series therewith. A gas release device on a side of the second section of the pressure vessel and releases gas from at the last of said compartments in the series. The gas release device is positioned at a specified location in the compartment to maintain the first gas void and the second gas void at predetermined volumes. A water discharge port in the third section of the pressure vessel outputs treated water from the pressure vessel. The third section of the pressure vessel connects the two or more compartments of the second section to allow water from the flooded zones of the two or more compartments to mix to produce the treated water. The multi-stage oxygenation system is secured and stabilized at a predetermined depth.

In an exemplary embodiment, the interface between the first section and the second section of the pressure vessel includes a plate with a plurality of openings to form the water jets.

In an exemplary embodiment, the water delivery mechanism includes a pipe disposed in a center of the pressure vessel and extending through the first, second, and third sections. A manifold is connected to the pipe and to the interface between the first section and the second section of the pressure vessel. The pipe delivers the water to the manifold, and the manifold delivers the water to each of the two or more compartments via the interface between the first section and the second section of the pressure vessel. The at least one baffle is attached to the pipe and an interior wall of the pressure vessel to create the two or more compartments in the second section of the pressure vessel.

In an exemplary embodiment, the first section of the pressure vessel includes a chamber that can be flooded with water by the water delivery mechanism. The interface between the first section and the second section of the pressure vessel includes a plate with one of a plurality of openings to form the water jets to deliver the water to the two or more compartments at a predetermined water pressure, or at least one nozzle to form the water droplets to deliver the water to the two or more compartments at the predetermined water pressure.

In an exemplary embodiment, the gas release device includes one of a float valve or an off-gas vent. The off-gas vent includes a connector connected to the pressure vessel, a right-angle coupling connected to the connector, and a tube connected to the right-angle coupling. An open end of the tube defines a location of the free surfaces of the flooded zones of the two or more compartments.

In an exemplary embodiment, the water discharge port is coupled to a pressure control valve that maintains the pressure vessel at a predetermined pressure.

In an exemplary embodiment, the predetermined pressure regulates oxygen exchange from the gas to the water and facilitates nitrogen removal from the water, and the predetermined pressure preferably simulates a depth of 100 ft.

In an exemplary embodiment, reactor off-gas containing oxygen and nitrogen is vented from all of the two or more compartments of the second section of the pressure vessel via the gas release valve.

In an exemplary embodiment, the pressure vessel is secured and stabilized in position via at least one of ballast and a mooring structure, or a pipe riser configured to deliver the water to the water delivery mechanism.

In an exemplary embodiment, where the multi-stage oxygenator system further includes a submersible pump attached to the pipe rise to pump water through the pipe riser to the water delivery mechanism. The pump forms at least part of the ballast stabilizing the multi-stage oxygenator.

In an exemplary embodiment, water jets or water droplets impact the first and second free surfaces of the two or more compartments to form bubble entrainments zones in each of the two or more compartments. Stilling zones are disposed between the bubble entrainment zones and the third section of the pressure vessel in each of the two or more compartments. Bubbles in water in the stilling zones coalesce and rise to a respective one of the first and second free surfaces and a respective one of the first and second gas voids thereafter.

In an exemplary embodiment, the multi-stage oxygenator system further includes a pump coupled to the water delivery mechanism and which pumps the water from a water source into the water delivery mechanism. A screen is coupled to an intake of the pump and to screen solids from the water. The water source is a body of fresh water or a body of salt water.

In an exemplary embodiment, the multi-stage oxygenator system further includes at least a second baffle oriented perpendicular to the at least one baffle and which separates downward flowing bubbles in the flooded zone of at least one of the two or more compartments from upward flowing bubbles in the at least one of the two or more compartments. The second baffle is attached to an inner wall of the pressure vessel.

In an exemplary embodiment, the multi-stage oxygenator system further includes a vent to vent gas from the pressure vessel during at least one of installation, maintenance, and retrieval of the pressure vessel.

In an exemplary embodiment, the water delivery mechanism includes at least one distribution plate with a predetermined number of orifices distributed within one or more zones of the at least one distribution plate and no orifices in at least one remaining zone of the at least one distribution plate. The water flows through the orifices of the at least one distribution plate into the two or more compartments. The orifices in the at least one distribution plate are arranged in double rows to form orifice groups separated by gaps that include no orifices. The orifice groups are arranged to cover a predetermined amount of linear area based on hydraulic loading corresponding to a predetermined application of the multi-stage oxygenator system.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1a shows a top view of a standard liquid distribution plate and a side view of a single chamber depicting bulk flow using a related distribution plate;

FIG. 1b shows a top view of a side-flow distribution plate and a side view of a single chamber depicting bulk flow using the side-flow distribution plate, according to an exemplary embodiment of the present disclosure;

FIG. 2a shows a top view of a side-flow distribution plate placed over an oxygenation system having six chambers, according to an exemplary embodiment of the present disclosure;

FIG. 2b shows a top view of head-space gas movement through the oxygenation system having six chambers, according to an exemplary embodiment of the present disclosure;

FIG. 2c shows a side view of an oxygenation system having two counter rotating circulation cells in the bubble entrainment zones for each of the six chambers, according to an exemplary embodiment of the present disclosure;

FIG. 3 shows a side view of a single chamber employing the side-flow distribution plate, as well as vertical and horizontal baffles, to encourage bubble release uniformly across the stilling zone width, according to an exemplary embodiment of the present disclosure;

FIG. 4 shows a top view of a distribution plate having two sets of orifices, and a side view of a chamber employing the distribution plate to create jets along two ends of chamber walls, according to an exemplary embodiment of the present disclosure;

FIG. 5 shows a top view of a distribution plate having four sets of orifices and three solid regions between the orifices, and a side view of a chamber employing the distribution plate to create two sets of jets along two ends of chamber walls, and two sets of jets along a vertical baffle, according to an exemplary embodiment of the present disclosure;

FIG. 6a shows a top view of head-space gas movement through a circular oxygenation system having six chambers, and a top view of a distribution plate portion that can be used for each chamber, according to an exemplary embodiment of the present disclosure;

FIG. 6b shows a top view of head-space gas movement through the circular oxygenation system having six chambers, and a top view of a distribution plate that can be used for each chamber to create counter rotating circulation cells, according to an exemplary embodiment of the present disclosure;

FIG. 7a shows a top view of head-space gas movement through a circular oxygenation system having ten chambers, and a top view of a distribution plate that can be used with the system, according to an exemplary embodiment of the present disclosure;

FIG. 7b shows a top view of head-space gas movement through a circular oxygenation system having six chambers, and a top view of a distribution plate that can be used with the system, according to an exemplary embodiment of the present disclosure;

FIG. 8a illustrates a side-flow distribution plate modification related to salt water treatment according to an exemplary embodiment of the present disclosure;

FIG. 8b illustrates another side-flow distribution plate modification related to salt water treatment according to an exemplary embodiment of the present disclosure;

FIG. 8c illustrates a side-flow distribution plate modifications related to salt water treatment according to an exemplary embodiment of the present disclosure;

FIG. 9 shows a flowchart of a method, according to an exemplary embodiment of the present disclosure;

FIG. 10a shows a top view of a distribution plate having two sets of orifices, and a side view of a chamber employing the distribution plate to perform stripping using a scrubbing insert, according to an exemplary embodiment of the present disclosure;

FIG. 10b shows a top view of a distribution plate having two sets of orifices, and a side view of a chamber employing the distribution plate to perform stripping using a scrubbing insert, according to an exemplary embodiment of the present disclosure;

FIG. 10C shows a top view of a distribution plate having two sets of orifices, and a side view of a chamber employing the distribution plate to perform stripping using a scrubbing insert, according to an exemplary embodiment of the present disclosure;

FIG. 11 shows a flowchart of a method, according to an exemplary embodiment of the present disclosure;

FIG. 12 shows a side view of a sub-surface multi-stage oxygenation system suspended at depth and employing a side-flow water distribution plate;

FIG. 13a shows a top view of gas flow movement within the multi-stage oxygenation system illustrated in FIG. 12;

FIG. 13b shows a side view of gas flow movement within the multi-stage oxygenation system illustrated in FIG. 12;

FIG. 14 shows a side view of a sub-surface multi-stage oxygenation system suspended at depth and allowing coupling with existing semi-contained net pen suction lines;

FIG. 15 shows a side view of a sub-surface multi-stage oxygenation system suspended at depth and allowing existing net pen pumping action to pull water into the system without an auxiliary axial flow pump;

FIG. 16 shows a side view of a sub-surface multi-stage oxygenation system suspended at depth, whether by anchoring or mooring, and allowing for hydrostatic pressurization via linkage to a deep RAS fish tank;

FIG. 17 shows a side view of a sub-surface multi-stage oxygenation system suspended at depth, whether by anchoring or mooring, and employing spray nozzles; and

FIG. 18 shows a top view of gas flow movement within the spray nozzle based sub-surface multi-stage oxygenation system illustrated in FIG. 17;

FIG. 19 shows a side view of a sub-surface multi-stage oxygenation system suspended at depth and employing spray nozzles;

FIG. 20 shows a perspective view of placement of a sub-surface multi-stage oxygenation system relative to a fish pen according to an exemplary embodiment of the present disclosure;

FIG. 21 shows another perspective view of placement of a sub-surface multi-stage oxygenation system relative to a fish pen according to an exemplary embodiment of the present disclosure; and

FIG. 22 shows a two-stage oxygenator with back pressure control according to an exemplary embodiment of the present disclosure.

### DETAILED DESCRIPTION

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). Reference throughout this document to “one embodiment”, “certain embodiments,” “an embodiment”, “an implementation,” “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

This disclosure is directed towards new submerged multi-stage reactor (oxygenator) designs that exploit the positive effects of hydrostatic pressure on gas transfer. This new design improves TE and AE, as well as reducing required reactor volume. The described reactor operates submerged with gas-liquid interfacial area provided by a conventional or side-flow water distribution plate that can be modified for a reduced saltwater hydraulic loading limit or a group of full-cone type spray nozzles when biofouling rates are high. As can be appreciated other spray nozzles, other than full-cone type spray nozzles, can be used without departing from the scope of this disclosure.

The systems and methods described herein allow for economical and effective treatment of aqua-cultural waters with commercial oxygen for oxygenation, and for nitrogen and/or carbon dioxide stripping so as to increase production capacity while also reducing the potential for gas bubble disease.

An advantage of the side flow distribution plate designs discussed herein lies with their unique capability to enhance gas transfer for selected spray fall heights or to reduce spray fall heights required for a target DO supplementation rate. Both responses act to decrease water treatment costs. Further, the new plate designs open up the possibility of modifying the chamber, with minimal effort, to allow for concurrent DC stripping. The latter modification can reduce energy costs linked to DC control. While the focus of this application is on aqua-cultural applications, the advantages of the described oxygen transfer system will also extend to other oxygenation applications, such as in municipal or industrial wastewater treatment.

The present disclosure describes a gas-liquid chamber feedwater distribution plate and structure, designed to extend standard perforated plate performance without additional energy input (pumping). The plate design, and unique application method described herein, provides a local increase in momentum transfer, thereby creating elevated shearing forces, promoting development of a well-defined circulation cell, or cells, within a chamber, and causing (1) acceleration of the vertical displacement of bubble swarms, (2) increases in penetration depth (Hp), (3) ascension of bubbles throughout regions of the pool not receiving feed water jets, and (4) promotion of re-exposure of water present in the chamber to the action of jets through enhanced mixing. Physical changes 1-4, combined, result in enhanced rates of gas transfer for selected spray fall heights (L_{O}), or reduced L_{O} requirements for a desired DO supplementation rate.

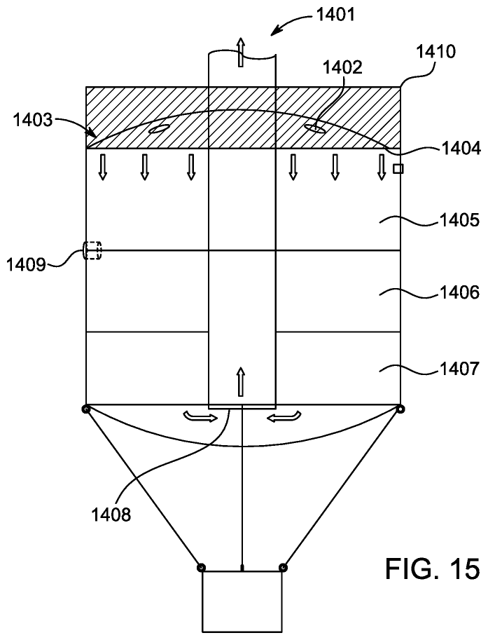

Sub-surface operation allows for dramatic increases in oxygenator performance due to hydrostatic pressure effects including increases in DO out, oxygen transfer rate, AE and TE. In an embodiment, the reactor is submerged at a depth that provides a local hydrostatic pressure within the submerged reactor assembly that exceeds local barometric pressure by at least 100 mmHg. This reactor type takes advantage of the deep waters available in net pen and semi-contained net pen applications and may also exploit the existing suction lines/bulk flows being used to increase water exchange rates in the culture units to both dilute and carry treated waters into the enclosures. In one embodiment, illustrated in FIG. 15 existing net-pen pumps are used to induce flow through the reactor without requiring an additional axial flow pumping step, thus reducing capital requirements. The effects of wave action on reactor performance may be minimized by creating a shock absorbing like effect on support cabling through use of flexible rods, springs, and gas pistons at the attachment point of the cabling on the reactor or on the net pen support structure.

The distribution plates discussed herein may free up space in the head-space region of chambers to perform DC stripping. Previous spray tower oxygen absorbers for concurrent DC stripping avoided the problems with the air stripping step in related systems by allowing DN in an RAS to drop below saturation concentrations, thereby reducing oxygen feed requirements and lowering total dissolved gas pressures below levels that result in gas bubble disease. In operation, DC desorption was achieved by directing head space gases from the spray tower (e.g. O₂, N₂, CO₂) through a sealed packed bed scrubber receiving a sodium hydroxide (NaOH) solution. DC was selectively removed from the gas stream by chemical reaction, forming the product Na₂CO₃. Scrubber off-gas, lean with regard to CO₂ but still rich in O₂, was subsequently redirected through the spray tower for further stripping of CO₂ and absorption of O₂. Make-up NaOH was fed into the scrubbing solutions recirculation sump as directed by a pH-based control loop. Spent NaOH solution, collected as an overflow, was then regenerated for reuse in a batch process that used relatively inexpensive hydrated lime (Ca(OH)₂). Scrubber irrigation rates represented a fraction of the spray tower water flow rates. While effective, this modification required two sealed gas transfer units coupled with a blower-assisted gas recirculation loop. This requirement can be dropped when using the new distribution plate design according to the present disclosure, as the new distribution plate design frees up about 75% of the head space volume available in a gas-liquid contacting chamber, according to one embodiment. In one embodiment of the present disclosure, the scrubbing unit is nested within the chamber's head space and positioned immediately adjacent to feed water jets. This allows for diffusion and/or a redirection of entrained gas, which is CO₂ rich, into the scrubber component for reaction with NaOH or other CO₂ scrubbing reagents (e.g. hydrated lime).

In exemplary applications discussed herein, packing is absent from individual chambers, thus relying solely on water jets developed by water distribution plates to provide needed gas-liquid interfacial areas. The latter is provided by jet surfaces as well as by the impact of the jets on the free surface of water within the chamber. Gas entrainment occurs at the impact site with bubbles forced, under turbulent conditions, to a depth of up to 0.5 m, according to one embodiment. Bubble size, entrainment depth and the resulting mass transfer potential is related to water salinity, jet diameter, jet velocity, spray fall height, temperature, and surface hydraulic loading on the feed water distribution plate. The surface hydraulic loading on the distribution plate, in freshwater applications, is limited to about 68 kg/m²/sec, which correlates to a downflow water velocity in the stilling zones of the gas-liquid contacting chambers of 6.8 cm/sec. Operating above this critical velocity, with a stilling zone depth of about 46 cm, can cause entrained gas to be swept out of the discharge end of the gas-liquid chambers, wasting oxygen enriched gas, and thus reducing AE.

The standard gas-liquid contacting chamber, without packing, relies on water jets developed by perforated water distribution plates to provide gas-liquid interfacial areas required for gas transfer. The plates used, to date, place jet locations uniformly over chamber cross sections. This disclosure describes more efficient distribution plate designs that focus jet action over limited areas of the chamber's cross section. Here the number of jets is fixed and equal to the standard plate requirements but spacing between jets is reduced by a factor of up to 80%. Further, the jet group created is positioned, strategically for example, along one side or at the end of a standard rectangular gas-liquid contact chamber allowing a wall effect to direct water and entrained gas bubbles to flow parallel to the free surface of the chamber, at depth, prior to ascending towards the head space region of the chamber. The result is to increase local turbulence and gas hold up while still complying with criteria established for hydraulic loading (e.g. 68 kg/m²/sec). Turbulence and gas hold up, in turn, influence the overall mass transfer coefficient (K_{L}a) that governs the rate of gas transfer along with the dissolved gas deficit (C*−C). In differential form, the relationship is expressed as:

$$\frac{d c}{d t} = {( {K}_{L} a )}_{T} ( {C}^{*} - C ) \qquad ( 1 )$$

The coefficient K_{L}a reflects the conditions present in a specific gas-liquid contact system. This coefficient is defined by the product of the two ratios (D/L_{f}) and (A_{f}/Vol), where D is a diffusion coefficient, L_{f} is liquid film thickness, and A_{f} is the area through which the gas is diffusing per unit volume (Vol) of water being treated. Values of K_{L}a increase with temperature (° C.) given viscosity's influence on D, L_{f} and A_{f} as described by the expression:

$${( {K}_{L} a )}_{T} = {( {K}_{L} a )}_{20} {( 1.024 )}^{T - 20} \qquad ( 2 )$$

Although each gas species in a contact system will have a unique value of K_{L}a, relative values for a specific gas pair are inversely proportional to their molecular diameters:

$$\frac{{( {K}_{L} a )}_{1}}{{( {K}_{L} a )}_{2}} = \frac{{d}_{2}}{{d}_{1}} \qquad ( 3 )$$

Equation (3) provides a convenient means of modeling multicomponent gas transfer processes, such as the addition of DO and the stripping of DN and DC, which occurs concurrently in pure oxygen absorption equipment. The dissolved gas deficits (C*−C) that drive gas absorption and desorption rates are manipulated within the boundaries of the gas-tight chambers by elevating the mole fraction, X, of oxygen above that of the local atmosphere (0.20946) with the oxygen feed. That is, the saturation concentration of a gas in solution (C*) is determined by its partial pressure in the gas phase (Pᵢ), liquid temperature and liquid composition as related by Henry's law. In equation form:

$${C}^{*} = B K 1000 ( \frac{X ( {P}_{T} - {P}_{{H}_{2} O} )}{760.} ) \qquad ( 4 )$$

where B is the Bunsen solubility coefficient, K is a ratio of molecular weight to molecular volume and P_{H2O} is water vapor pressure. Partial pressure (Pᵢ) represents the product of total pressure (P_{T}) and gas phase mole fraction X following Dalton's Law:

$${P}_{i} = ( {P}_{T} ) ( X ) \qquad ( 5 )$$

Within an exemplary sub-surface oxygenator described herein, C*_{O2} is increased through elevation of hydrostatic pressure, at depth, as well as through elevation of X_{O2}. Both factors work together to accelerate the rate of gas transfer thus minimizing equipment scale and providing for an effluent DO level in excess of the local air saturation concentration. Ignoring the effects of minor gas species, increases in X_{O2} will concurrently reduce the mole fraction and hence the C* of DN following the relationship X_{N2}=1−X_{O2}. The negative dissolved gas deficits that often result provide for DN stripping. DN stripping potentials, however, decrease as hydrostatic pressure in the reactor increases. Given the potential for gas bubble disease, the net effect of changes in DO and DN, following dilution, preferably will not result in exposure of fish to total dissolved gas pressures (TGP) that exceed local barometric pressures (Bp), i.e., Delta P is preferably less than or equal to BP where Delta P=TGP−BP. TGP represents the sum of dissolved gas tensions (GT, mm Hg) for all gas species (i) present. GT; is defined as the product (Cᵢ) (760/1000 Kᵢ)(Bᵢ). In an exemplary sub-surface oxygenator described herein, the C* of O₂ is increased through elevation of hydrostatic pressure, at depth, as well as through elevation of X_{O2}. Both factors work together to accelerate oxygen transfer. Stripping DN may move N₂ into the reactor chambers' head space (gas) reducing the mole fraction of oxygen, X_{O2}, the C* of O₂ and, in turn, the dissolved gas deficit that governs gas transfer rates (Equation (1)). The gas phase composition of the head space within each chamber is homogeneous given mixing forces related to jets and sprays as well as to very low operating gas to liquid feed ratios. Under these conditions, multi-staging is applied as a physical method of elevating the mean dissolved gas deficit above that provided by single stage reactors sharing a homogeneous gas phase. In multi-staging, feed gas with a reduced X_{O2} is directed through adjacent gas-liquid contacting chambers operated in series with regard to the gas stream, but in parallel with regard to the liquid feed. The continued re-exposure of the head space gas to the low DO concentrations in the liquid feed, as it proceeds toward the gas discharge port in the last stage, provides significant improvements in oxygen transfer rates, AE and TE. It follows that the decrease in X_{O2}, stepwise, across each stage causes the DO in chamber specific discharges to vary from a relatively high value in the first stage to a relatively low value in the last stage. Exemplary sub-surface oxygenators described herein employ a blending zone below chamber boundaries within the reactor to force mixing and thus provide for a homogeneous DO concentration in the reactor's discharge.

Liquid jets and sprays provide the gas liquid interfacial area needed in both the head space (gas void) and entrainment zones of the sub-surface oxygenator to maintain an acceptable value of K_{L} (Equation (1)). Air entrainment of a plunging liquid jet, for example, increases with the velocity-dependent Froude Number FR: FR=V²/(g*d) where V is velocity, g is gravity and d is nozzle diameter. The velocity of the jets exiting the inventive distribution plates (Vₒ) are, by design, relatively low given the need to minimize pressure drop. Jet velocity at the impingement point, however, represents the sum of Vₒ plus velocity gains from gravity as described by the relation: Vj=(Vₒ²+2 gL)^{0.5} where L is the elevation change from the nozzle discharge to the free surface receiving the jet. Gravity effects on Vj are significant. For example, with a pressure drop of 15.2 cm H₂O across the orifice Vₒ is 1.38 m/s but increases by a factor of 2.64 to a Vj of 3.65 m/s when L is just 0.609 m. The net power of the jet (Nj), which promotes K_{L}a, increases with the square of Vj at a given volumetric flow rate Q: Nj=0.5 Qp Vj², where Nj is in Watts and p is liquid density.

The positive effect of Nj on K_{L}a is due to enhanced momentum transfer from the jet increasing the volume and penetration depth of entrained gas as well as turbulence/shear forces acting to reduce bubble diameter and associated liquid film thickness (L_{f}, Equation 1). Small bubbles provide longer ascension exposures in the receiving pool as well as more surface area, A, than large bubbles. Nj in freshwater applications has been restricted by (1) the hydraulic loading rate criteria of about 68 kg/m²/sec designed to eliminate bubble carryover in the effluent and (2), the need to minimize feed water head requirements at the distribution plate. There is a need for more efficient distribution plate designs that provide the benefits described of an increasing Nj without exceeding limitations 1 and 2 above. This disclosure addresses this need by manipulation of the orifice plate hole schedule and by exploiting the unique geometry of individual gas-liquid contacting chambers.

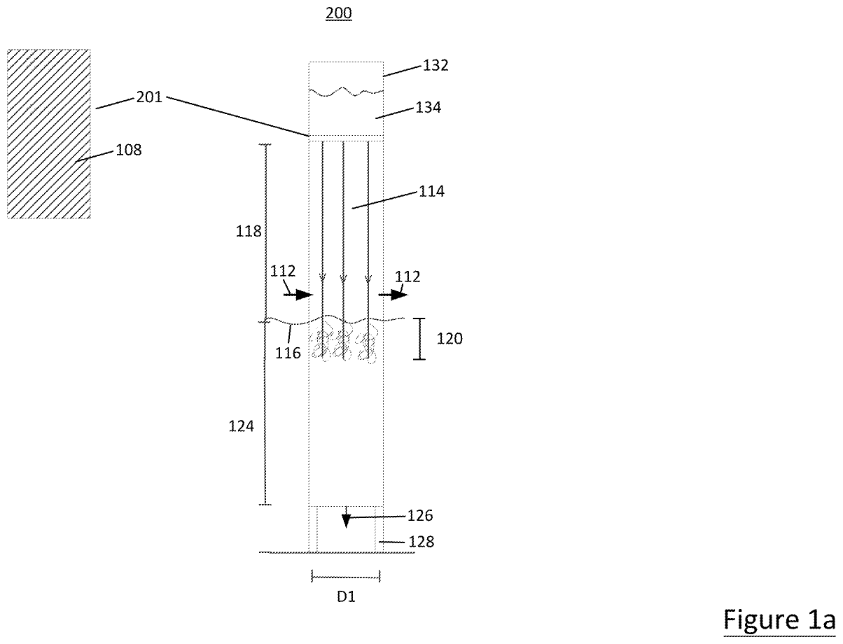

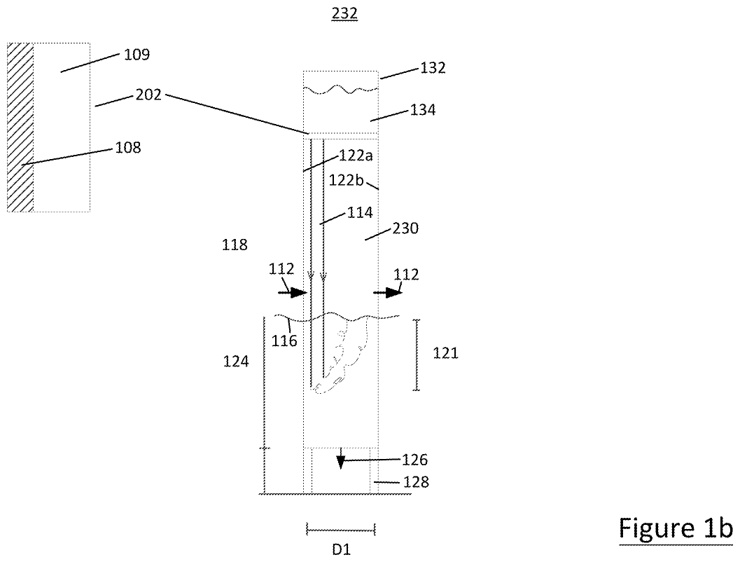

Referring now to the drawings, FIG. 1a illustrates a standard distribution plate 201 used in a chamber 200, where the width across the shorter dimension of the standard chamber 200 is represented by D₁. The standard distribution plate 201 includes a region (represented by the hashed lines) with orifices 108 distributed throughout. When liquid 134 is contained in the trough 132, the liquid 134 flows through the orifices 108 to form jets 114. The jets 114 fall through the spray fall zone or gas void 118, which includes gas (e.g. oxygen) that can be input/output using the gas ports 112. When the jets 114 contact the free water surface 116, they penetrate the water down to a particular depth, creating a bubble entrainment zone 120. Also shown in FIG. 1a is the stilling zone 124, discharge slot 126, and support legs 128 not used in sub-surface oxygenator applications. While the present exemplary embodiment includes a trough 132, other system configurations may use different containers in lieu of the trough 132, such as vacuum chambers or in the case of submerged reactors a gas tight pressure vessel. Further, the discharge slot 126 is optional. For example, if the LHO chamber 200 is to be a vacuum, the discharge slot 126 can be removed. Exemplary embodiments in a vacuum degasser or medium pressure oxygenator are discussed in more detail below.

In an example employing actual values, the standard distribution plate 201 has a uniform distribution of 29 jet orifices 108 (d=9.53 mm) over a single LHO chamber 200 with a cross section measuring 12.7 cm×35.6 cm. In use, jet impingement provides a point source of entrained head space gas. The bubbles formed in the bubble entrainment zone 120 are advected vertically downstream while diffusing radially. Radial expansion of the bubble swarm with depth reduces local turbulence and downward velocities, allowing bubble release and ascension in open areas between adjacent jets. Hence the bubble entrainment zone 120 is dynamic with gas moving in both vertical directions while bulk liquid flows steadily, with some dispersion, toward the lower discharge end of the chamber. When Q=170.3 l/min, Vₒ, based on Q/Aⱼₑₜ, is 1.37 m/sec. In this exemplary, L, of 0.308 m Vj rises to 2.803 m/s which provides an Nj for the sum of the jets of 11 Watts. The corresponding power applied per unit cross section is 243.4 Watts/m².

FIG. 1b illustrates a side-flow distribution plate 202 used in a chamber 232, according to an embodiment of the present disclosure. A first zone of the side-flow distribution plate 202 has orifices 108, while a second zone is a solid region 109 without orifices. Used in the chamber 232, liquid 134 in the trough 132 falls through the orifices 108 to create jets 114 along or adjacent to chamber wall 122a, but not chamber wall 122b. The jets 114 are not along chamber wall 122b because the solid region 109 of the side-flow distribution plate 202 prevents the liquid 134 from flowing through. In other words, there are portions of the free water surface 116 that are exposed to the jets 114, while there are other portions of the free water surface 116 not exposed to the jets 114. As the jets 114 pass through the spray fall zone (gas void) 118 and contact the free water surface 116, they penetrate the water to create a bubble entrainment zone 121, which is deeper than the bubble entrainment zone 120 created in the chamber 200 from FIG. 1a.

In an embodiment, FIG. 1b shows the new distribution of jet orifices 108 on the side-flow distribution plate 202. While the side-flow distribution plate 202 has the same dimensions and same number of orifices as the standard distribution plate 201 from FIG. 1a, the orifices are located in a sub-region of the side-flow distribution plate. Jets 114 are created in two parallel rows along or adjacent to the length of one side of the chamber (i.e. chamber wall 122a), focusing Nj over just 31.5% of the available area. While the total applied jet power Nj is identical to the standard design, the power applied per unit cross section (active area) is increased 3.18-fold to 774 Watts/m². The flow conditions established in the present embodiment are quite different than the standard design. For example, the increase in Nj applied in the limited jet impact zone along with the positioning of the jets 114 near or adjacent to the chamber wall 122a provides a local increase in momentum transfer, creating elevated shearing forces as well as promoting the development of a well-defined circulation cell that accelerates vertical displacement of the bubble swarm. This leads to a greater penetration depth, Hp, as the wall adjacent to nozzle positions constrains radial expansion of the diverging bubble swarm, forcing the release of bubbles, at depth, across the short dimension D₁ of the chamber 232. This results in the ascension of bubbles throughout regions of the pool not receiving feedwater jets 114. Field trials of the side-flow distribution plate 202, under the conditions of the above example, have demonstrated a 34.5% increase in Hp when compared to the standard distribution plate 201 design without undo bubble carryover in the chamber's effluent. Further, the circulation cell of bubbles developed in the bubble entrainment zone 121 increases the potential for re-exposure of feed water present in the chamber 232 to the action of the jets 114.

Flow rate and pressure drop of a system design determine the number of orifices needed for a specific distribution plate application. Orifice shape and diameter can vary. In an embodiment, the shape is circular with diameters ranging from 0.25 to 0.5 inches. The flow potential Q₁ of a single orifice can be derived from the energy equation

$${Q}_{1} = 3.1417 {( \frac{d}{2} )}^{2} {( 2 G H )}^{0.5} ( C L ) \qquad ( 6 )$$

where Q₁ is flow in

$$\frac{{ft}^{3}}{sec} ,$$

d is orifice diameter in feet, G is gravity

$$( 32.2 \frac{ft}{{sec}^{2}} ) ,$$

H is pressure drop across the orifice in feed water, and CL is the orifice geometry specific loss coefficient, which can vary from about 0.6 to 0.9 in one embodiment. CL decreases as the distribution plate thickness increases. Small diameter orifices can be more prone to fouling and physical blockage with solids than large diameter holes, but K_{L}a typically will decrease as orifice diameter increases. The total number of orifices required is then

$$\frac{{Q}_{t a r g e t}}{{Q}_{1}} ,$$

where Q_{target} is the total flow to be treated in

$$\frac{{ft}^{3}}{sec} .$$

In one embodiment, the area(s) of the distribution plate devoid of orifices can represent 65-80% of the total distribution plate area. In other words, the area(s) of the distribution plate having orifices can represent 20-35% of the total area of the distribution plate. Note that the area of the distribution plate having the orifices is not referring to the sum of the individual orifice cross sectional areas representing 20-35% of the distribution plates area but is instead referring to the area of the distribution plate that is involved; this includes the area between the individual orifices, the space between the first row of orifices and the chamber walls as well as the orifice cross sectional areas. Thus, when the one or more areas of the distribution plate having the orifices cover an area between 20%-35% of a total area of the distribution plate, only a fraction of that area will be made up by the cross-sectional areas of orifices.

Orifices can be spaced accordingly to a minimum spacing between an orifice location and a chamber wall selected so as to avoid clinging wall flow that would interfere with jet impingement. This offset can be 0.5 to 1.5 inches in one embodiment, but can vary with orifice diameter and spray fall height. Further, orifice spacing can be designed to avoid jet to jet interaction in the spray zone or head space of the chambers. The orifices may occupy substantially half of a length of a wall of a chamber.

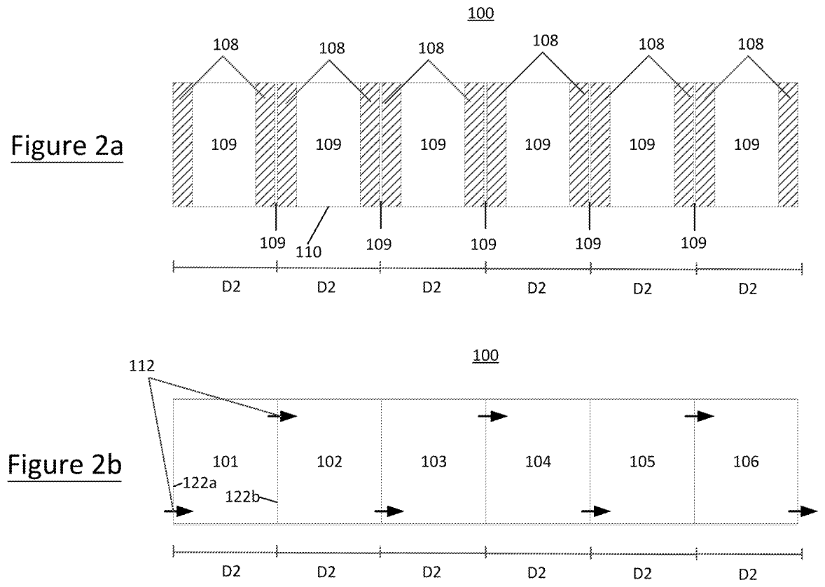

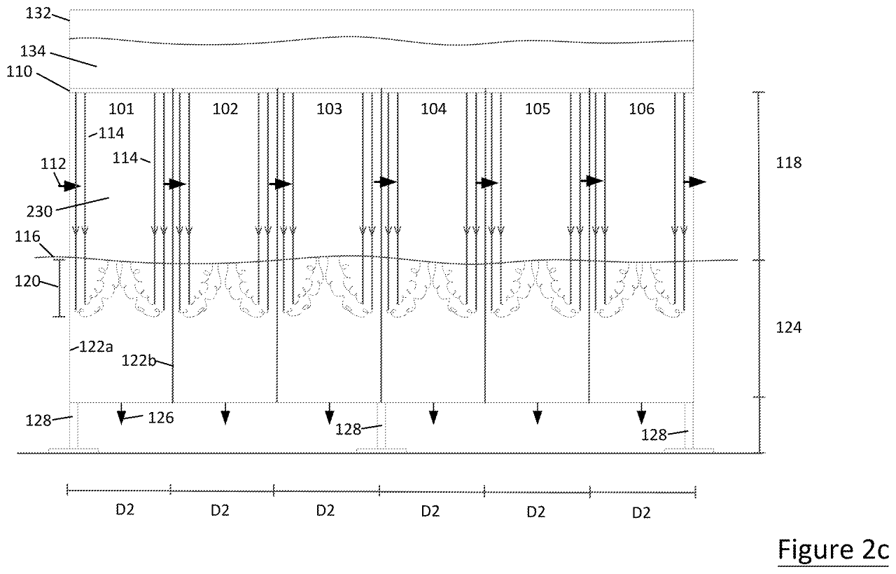

Of course, the above examples illustrate only one embodiment, and many variations can exist. For example, FIG. 2a shows a cross sectional top view of a distribution plate 110 installed in a rectangular oxygenator 100 having six chambers 101, 102, 103, 104, 105, 106, according to one embodiment. The width across the shorter dimension of each of the six chambers 101, 102, 103, 104,105, 106 is D₂, where D₂=2*D₁. The distribution plate 110 has multiple regions of orifices 108, as well as one or more solid regions 109 between regions of orifices 108. In one embodiment, a single distribution plate can be installed over multiple chambers making up the oxygenator. Alternatively, in one embodiment, a corresponding distribution plate can be installed over each chamber making up the oxygenator.

FIG. 2b shows a cross sectional top view of the oxygenator 100 having six chambers 101, 102, 103, 104, 105, 106, where each chamber has chamber walls. For example, chamber 101 has chamber walls 122a and 122b. Also shown are gas ports 112, which allow gas to flow through the head-space region of each chamber. The gas ports 112 can be an off-gas vent and/or a gas feed source. Note that adjacent gas ports 112 are offset from each other, allowing gas to travel throughout respective chambers. For the sake of simplicity, chambers walls and gas ports for chambers 102, 103, 104, 105, 106 are not labelled, though it should be understood they exist.

FIG. 2c shows a side view of the oxygenator 100. In chamber 101, jets 114 fall along chamber walls 122a, 122b on both sides, leaving an inner portion of the free water surface 116 in chamber 101 unexposed to the jets 114, and thereby creating two counter rotating circulation cells in the bubble entrainment zone 120. This scenario discussed with respect to chamber 101 also happens for the other chamber 102, 103, 104, 105, 106 in the oxygenator 100.

In an embodiment, the design shown in FIGS. 2a, 2b, and 2c incorporates six identical chambers 101, 102, 103, 104, 105, 106 (i.e. reactor stages) with a total flow capacity of about 2044 l/min. Total head loss across the oxygenator 100 is just 0.74 m. Liquid 134 (e.g. water) flows into the inlet trough 132 by gravity, then is distributed along both sides of individual chamber walls for each chamber 101, 102, 103, 104, 105, 106 via the distribution plate 110.

In an embodiment, referring to FIG. 2a, the top view of the oxygenator 100 with the distribution plate 110 installed provides the orifice locations on the distribution plates 110—29 jets per chamber wall, distributed in two rows over an area representing 15.9% of each chambers' width (25.4 cm), i.e., row one and row two are 2.4 and 3.6 cm from the chamber walls, respectively. The effective diameter of the orifices 108 is 9.53 mm. The water level in the inlet trough 132 is about 12.7 cm. Jets 114 developed drop 61 cm through the head space regions 230 of each chamber 101, 102, 103, 104, 105, 106 before impacting the free water surface 116 of the stilling zone. Treated water exits an individual chambers lower open end that is 10.2 cm above the floor of the receiving sump via discharge slots 126.

In an embodiment, the top view of FIG. 2b, shown without the distribution plate 110 installed, also indicates gas flow direction as the gas moves in series through chambers 101, 102, 103, 104, 105, 106 via gas ports 112 prior to exiting a 1.9 cm diameter off-gas vent. The gas moves via a pressure differential generated by an oxygen feed source.

In an embodiment, the end view in FIG. 2c shows the position of the feed gas inlet port 112 (0.64 cm diameter) affixed to the chamber wall 122a for chamber 101 at an elevation above that of the free water surface 116 of the stilling zone. Internal chamber walls (e.g. chamber wall 122b) have a single 1.9 cm diameter gas port at this same elevation. These ports alternate between positions 5 cm ahead of the back wall, or 5 cm behind the front wall, to establish the tortuous path (gas flow) shown.

Of course, oxygenator chambers can vary in geometry as well as scale. They could, for example, incorporate nested rectangular dimensions, such as those shown in FIGS. 1a, 1b, 2a, 2b, and 2c, but most are wedge shaped to accommodate subdivision of a sub-surface oxygenator with circular cross-section. Froude-based scaling of hydraulics, such as the circulation cell described, is valid in those cases where gravity forces predominate, and a free surface is involved. Geometric similitude, with scale-up, requires identical depth to width ratios in the receiving pool. Using Hp as depth in the example above, and the short dimension of the chamber as width D₁, provides a depth to width ratio, R_{L} of 1.75. Increasing the feed water flow rate Q_{L} in a new design with Lₒ and number of chambers fixed at 0.308 m and 6, respectively, will require wider chambers to accommodate surface loading rate criteria and a growing number of jets per chamber. If it is assumed that Hp is fixed with regard to Lₒ, then increasing chamber widths will decrease R₁ indicating scale-up will alter the preferred contacting conditions. This has been confirmed in laboratory trials. Tests show bubble plumes displaced from the jet wake, at depth, ascending to the surface of the pool without uniform distribution within the pool volume that exists outside of the jet impingement zone, causing the liquid volume within the chamber to be underutilized.

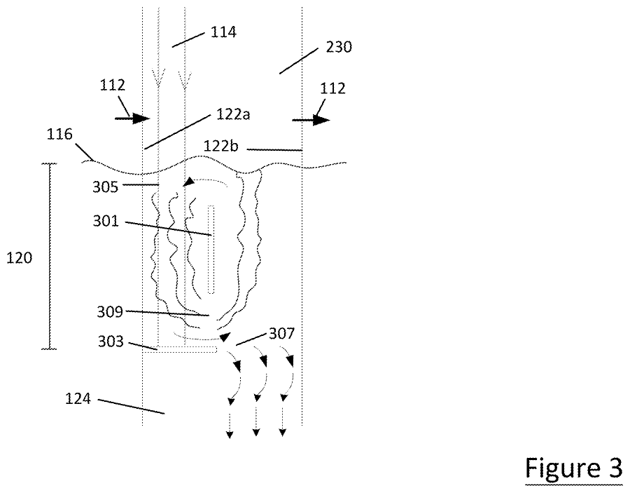

FIG. 3 shows a modification of the oxygenator chamber 232 that seeks to restore full utilization of chamber volume when reductions in R_{L} below 1.75 are limited. The vertical baffle 301 constrains jet 114 flux, limiting the interaction of downward and upward fluid flows, reducing drag, and allowing for higher bubble plume acceleration in the jet wake compartment 305. The horizontal baffle 303 directs this accelerated flow from chamber wall 122a towards the opposite chamber wall 122b, providing a more complete distribution of the bubbles over the chambers cross section 307. The vertical baffle's 301 position relative to the cross section 307, horizontal baffle 303, and chamber walls 122a, 122b can be related to Lₒ, Vj, jet locations and desired treatment effect. Note that the vertical baffle 301 is attached to the back chamber wall. Further, the vertical baffle 301 remains submerged, and therefore does not block movement of the pool surface waters into the jet wake compartment 305, allowing for the completion of the desired circulation cell. The horizontal baffle's 303 extension from the wall of the cross section 307, perpendicular to fluid flow, is limited to minimize pressure drop across the resulting slots open area 309. The baffles 301, 303 can be used together or individually based on R_{L}'s deviation from 1.75 or specific design objectives.

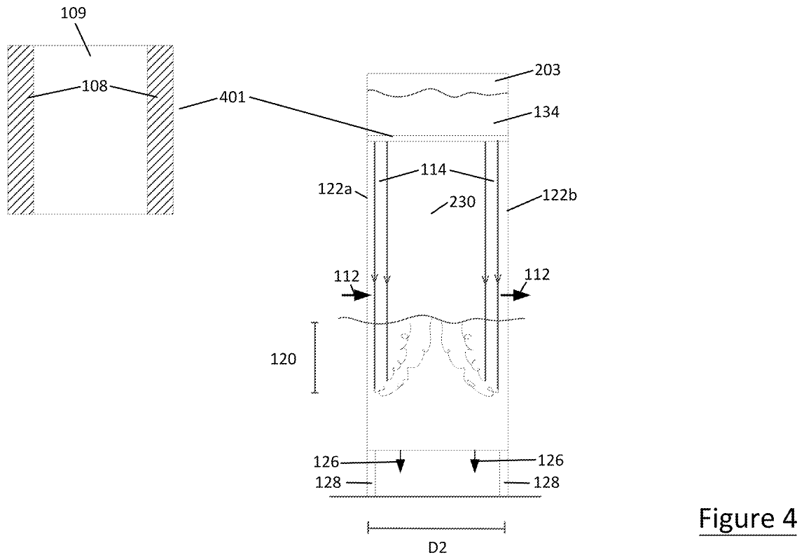

In those cases where chamber width increases are substantial, additional sets of jets can be added to meet performance targets. For example, FIG. 4 shows an exemplary configuration when the cell width of a chamber has been doubled (compared to LHO chamber 232) from 12.7 to 25.4 cm with R_{L} now 0.875. The distribution plate 401 is also shown, having orifices 108 along two sides, and a solid region 109 in between. Feed water flow rate, Q_{L}, is twice that of the previous example (2×170.3 l/min), as is the total number of impingement jets (2×29). In this new configuration, two counter rotating circulating cells are established with interaction at the midpoint of the chamber boundary D₂. Although not shown, the baffles 301, 303 presented in FIG. 3 could be applied, in pairs, to augment performance.

The strategy used to avoid cell distortion with R_{L}=0.875 can be applied when further reductions in R_{L} are necessary if (1) chamber width D₁ is increased in increments of the D₂ dimension and (2) Q_{L}/m² chamber cross section remains constant. For example, D₃ could be 50.8 cm (R_{L}=0.438), 101.6 cm (R_{L}=0.219), 152.4 cm (R_{L}=0.109) etc.

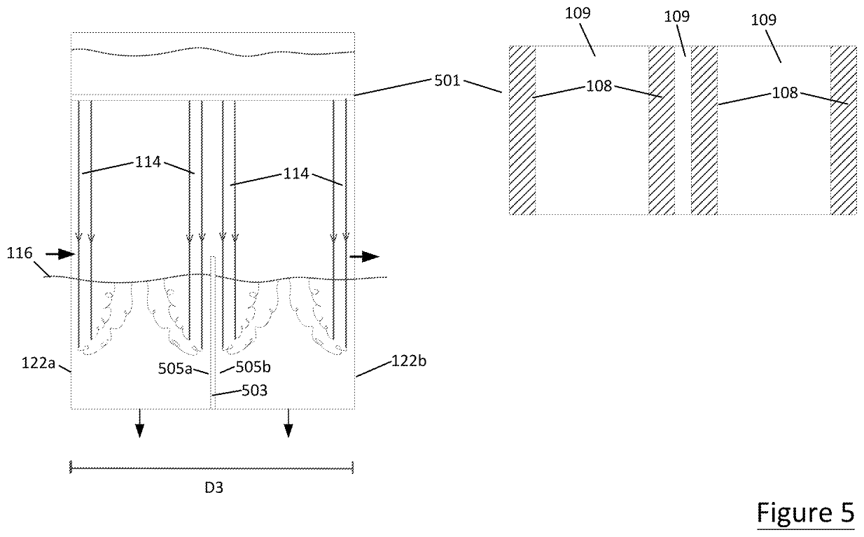

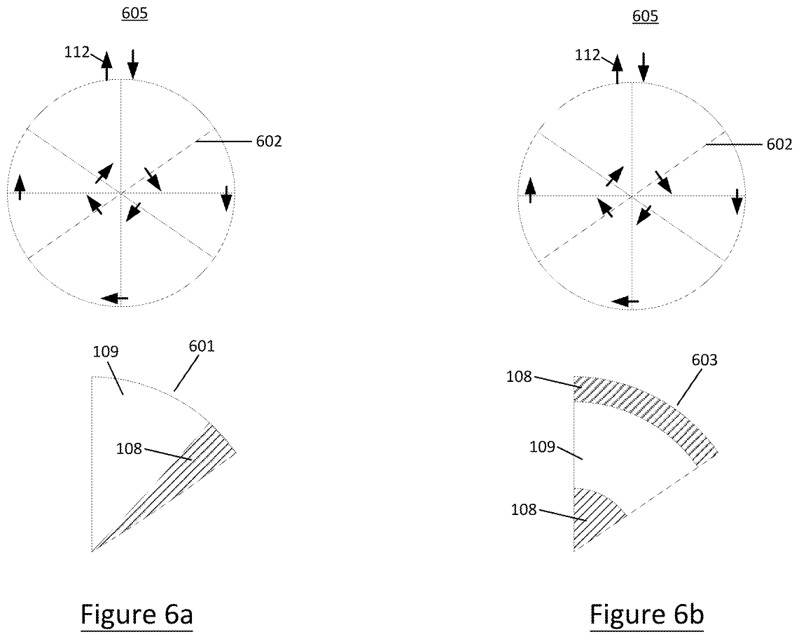

FIG. 5 shows the result when chamber width, D₃, is set equal to 2D₂ or 50.8 cm. Q_{L} in this embodiment is 4×170.3 l/min with 4×29 impingement jets 114 applying power at 4 points over D₃ along chamber walls 122a, 122b, and positions 505a, 505b adjacent to a baffle 503. The latter two points are adjacent to both sides of a shared vertical baffle 503 extending from a position above the pools free water surface 116 to a submergence level that exceeds Hₚ. The net result of the new configuration is the establishment of 2 pairs of counter rotating cells designed to replicate the gas-liquid contacting conditions illustrated in FIG. 3 despite an R_{L}=0.438. FIG. 5 also shows the resulting orifice 108 schedule for the distribution plate 501 with the two groups of jets offset from the chamber wall 122a, 122b, as well as both sides of the baffle 503 to minimize contact of these components, above the free water surface 116, with jet 114 flows. Similar offsets are used in the configurations illustrated in FIGS. 1a-1b and 3, as well as example plate designs for circular LHO systems as shown in FIGS. 6a and 6b.

FIGS. 6a and 6b provide two options for wedge-shaped chambers. FIGS. 6a and 6b show a cross sectional top view of a circular oxygenator 605 made up of eight wedge-shaped chambers, each chamber being divided by chamber walls 602. Here the central angle of the wedge (θ_{w}) can be small, typically less than 1 radian (57.3°), and so a uniform distribution of jet locations can be based on the relative area provided by the wedge cross section along the sectors radius (rₘₐₓ). For example, FIGS. 6a and 6b show a circular oxygenator 605 subdivided by eight linked wedges of equal area, providing a θ_{w} of 0.785 radians and a chamber cross sectional area of ½ r²ₘₐₓ θ_{w}.

Fixing the distribution of orifices 108, uniformly, over an area representing 31.5% of the available area, as in FIG. 2, sets an angle limit for orifice 108 placement that is equal to (θ_{w}) (0.315), or 0.247 radians (14.18°), as illustrated by the distribution plate 601 shown in FIG. 6a. Some distortion of the desired circulation cell will occur, unfortunately, given increasing levels of jet wake confinement as r approaches zero (rₘᵢₙ).

This same limitation is applied in a second option, shown by the distribution plate 603 in FIG. 6b, that attempts to replicate the two counter rotating cells shown in FIG. 3 by applying jet momentum uniformly along a zone near the sectors arc at rₘₐₓ as well as a zone near the origin of θ (rₘᵢₙ). FIG. 6b shows the active areas associated with both zones are, in this example, equal, i.e., ((½)(R²ₘₐₓ)(θ_{w})(0.315))/2.

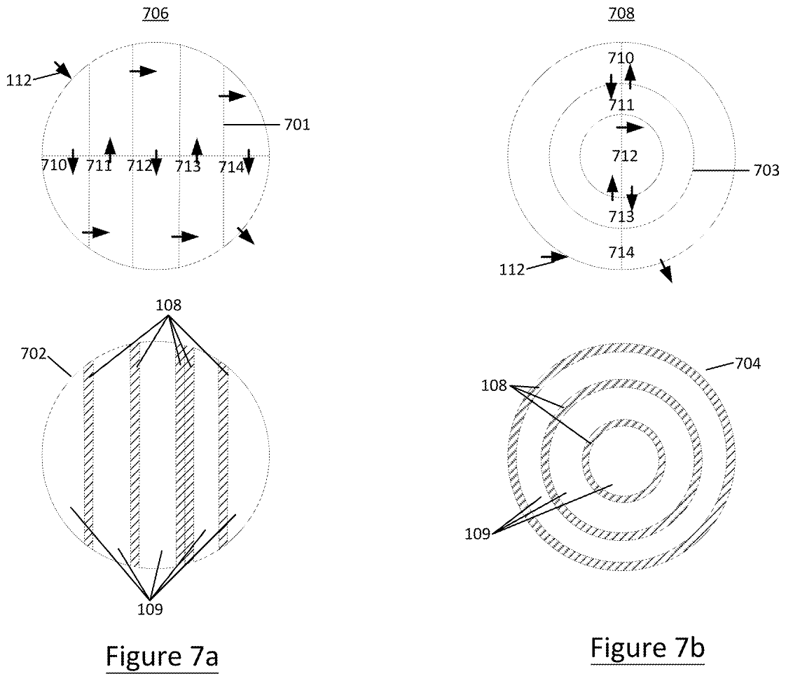

An alternate configuration shown in FIG. 7a avoids use of wedge-shaped chambers by establishing a group of parallel partitions that mimic the rectangular section R_{L}'s associated with FIG. 3, 4 or 5. The oxygenator 706 is made up of 10 chambers, defined by the chamber walls 701. A top view of the distribution plate 702 is also shown in FIG. 7a, which can be placed on top of the chamber walls 701.

Likewise, the configuration shown in FIG. 7b establishes these same R_{L} values in annular space created by a group of concentric chamber walls 703 in an oxygenator 708 having six chambers. An example of a distribution plate 704 that can be used in oxygenator 708 is also shown in FIG. 7b.

In one embodiment, optional water-tight bulkheads 710, 711, 712, 713, and 714 can be included in both alternative designs shown in FIGS. 7a and 7b to increase the number of chambers within the oxygenator system boundary, thus improving AE and TE. In one embodiment, the water-tight bulkheads 710, 711, 712, 713, and 714 are gas-tight (minus the gas ports that allow gas movement from one chamber to the next).

In one embodiment, orifice coverage in the distribution plate would be decreased to account for a reduction on hydraulic loading (HL). For example, HL for seawater applications is typically less than freshwater applications given that smaller bubble diameters are created in saltwater applications leading to deeper bubble penetration depths. To account for this the double rows of orifices would be positioned as discrete groups with equal length gaps between groups (e.g., a repeating schedule of 8 inches of orifice followed by 8 inches of no orifices).

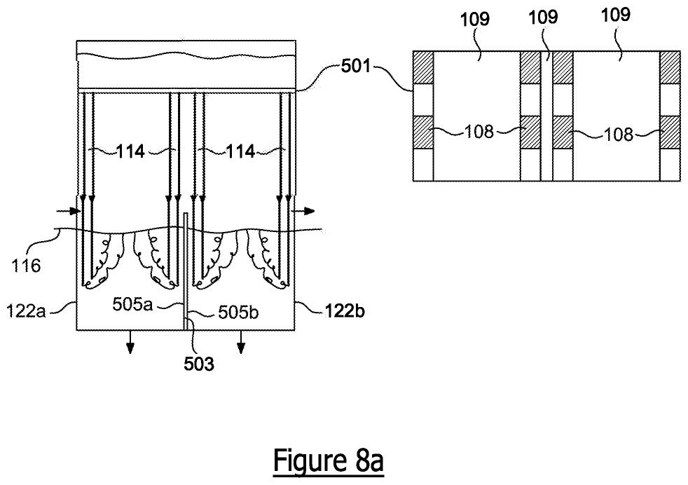

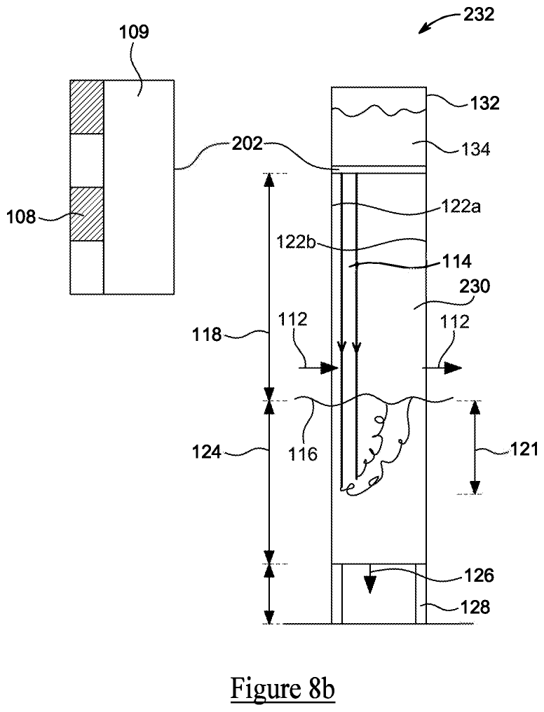

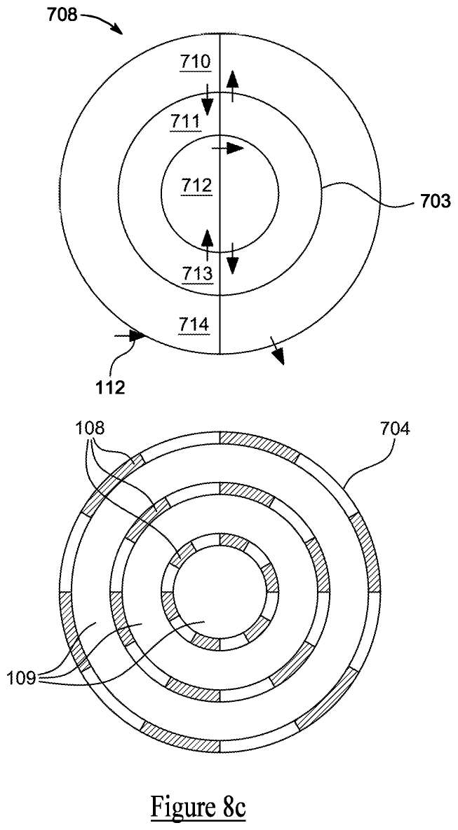

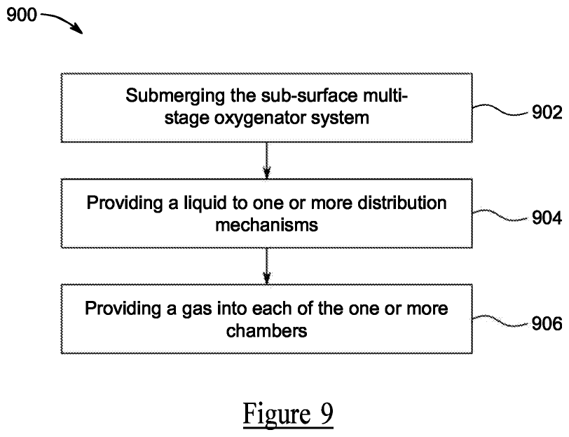

FIGS. 8a-8c show modified orifice schedules of gas diffusion plates corresponding to various chamber structures. The modified orifice schedules include the discrete groups of orifices with equal length gaps, in order to account for the lower HL of seawater applications.

FIG. 8a shows a quadruple width (20 inch width) chamber structure, along with the corresponding modified orifice schedule of the gas diffusion plate 501. In FIG. 8a, the hashed portion 108 indicates the areas having orifices, which are separated by equal length gaps. FIG. 8B shows the single side distribution case with a 5 inch cell width.

As shown in FIG. 8a, the gaps between the areas having orifices are aligned when more than one side of the reactor distribution plate is covered with orifices so as to encourage the creation of the opposing or counter rotating circulation cells shown in the side views of FIGS. 4 and 5. FIG. 8c shows how gaps would be created in the circular reactor cross section case.

FIGS. 8a-8c illustrate how water would be applied when, as in the present example, water flow rates are limited to 50% of the freshwater hydraulic loading limit. In other embodiments, the hydraulic loading limit due to saltwater use could be more or less than the 50% used in this example. If so, the gap areas between the orifice areas would be decreased or increased accordingly. For example if the hydraulic loading limit is increased to 75% of the freshwater target, then the gap areas would be equal to 25% of the linear areas covered with orifices, instead of the 50% reduction shown in FIGS. 8a-8c.

FIG. 9 illustrates a method 900 of performing high efficiency oxygenation using a sub-surface oxygenator system including two or more chambers, one or more distribution mechanisms disposed over corresponding chambers, and a gas input into each of the one or more chambers, according to an embodiment of the present disclosure.

In step 902, the sub-surface multi-stage oxygenator system is submerged at depth. This step is optional in that the oxygenator system may already be in position and submerged upon use. In this case, operation begins at step 904. In step 904, a liquid is provided to one or more distribution mechanisms such that the liquid forms jets or droplets that flow into the one or more chambers. Any of the distribution mechanisms described herein may be used, including the side-flow distribution plates or nozzles. In the embodiment of using the distribution plates as the distribution mechanisms, each of the distribution plates has a predetermined number of orifices uniformly distributed within one or more zones of the respective distribution plate and no orifices in at least one remaining zone of the respective distribution plate. The liquid flows through the orifices in the two or more distribution plates to create jets. Any of the distribution plates discussed herein, and variations thereof, can be used. The distribution plate, employing the side-flow technique discussed herein, should be tailored to accommodate the geometry of the oxygenator system (e.g. location of chamber walls, spray fall (gas void) height, number of chambers, and size of each chamber).

In step 906, a gas is provided through the gas input to each of the one or more chambers, causing the gas to flow through a head-space (gas void) portion of each of the one or more chambers, above a liquid stored in the one or more chambers. The jets formed in step 904 come into contact with the gas in the head-space portion of each chamber, then enter the liquid within the corresponding chamber at regions disposed directly below the distribution mechanisms to create one or more circulation cells of bubbles in the liquid held within the corresponding chamber. In one embodiment, horizontal and/or vertical baffles, fully submerged in the liquid, can be attached to a wall of the chamber, which can help to facilitate forming the one or more circulation cells of bubbles.

Tests were performed with the side-flow distribution plate 202 discussed with respect to FIG. 1b, as well as several additional configurations, to evaluate relative performance under typical field conditions. Specifically, both Hp and an oxygen transfer coefficient G at selected spray fall heights (L_{O}) were quantified. G results from the integration of Equation (1) and has been defined as: G=ln((C*−DOᵢₙ)/(C*−DOₒᵤₜ)), where DOᵢₙ and DOₒᵤₜ are, respectively, chamber influent and effluent DO concentrations. Measured G values were corrected to 20° C. based on Equation (2), then compared to G_{20C} established previously for a selected standard plate design (uniform distribution of orifices). A multi-component gas transfer model, specific to the oxygenator, and requiring G_{20C} as an input, was then used to predict relative performance (AE, TE, etc.) of both configurations. The test side-flow distribution plate was placed at a depth of 12.7 cm in a rectangular chamber measuring 1.219 m in height×0.508 m in width×0.127 m thick. The area created above the plate served as the feedwater trough when receiving water from an adjacent stilling zone served by a centrifugal pump. Pump flow was 157 l/min as regulated by a throttle valve and measured with a Signet type paddlewheel flow sensor. Windows placed on the side and end of the chamber allowed observation of the jets, jet impact zone (Hₚ) and stilling zone. The chamber was placed in a sump tank outfitted with additional windows and a water discharge valve used to regulate Lo via changes in pool surface. In operation, water entered the inlet trough, dropped by gravity into the impact zone, then exited the lower open end of the chamber while oxygen was directed into the head-space region at a rate that elevated X_{O2} to within the range 0.65-0.75. Oxygen flow rates were fixed by a Cole-Palmer variable area flowmeter and its integral throttle valve. X_{O2} was measured in chamber off-gas that was vented, continuously, via a 1.9 cm riser extending through the midpoint of the distribution plate and above the free surface of the trough water. X_{O2} was measured with both an Oxyguard Polaris TGP meter and a Quantek Model 201 Oxygen Analyzer. Once DO and X_{O2} had stabilized, the change in DO across the system was determined by measuring DO in the inlet trough and DO in the sumps effluent. DO measurements were made with a YSI Prosolo luminescent probe that also provided water temperature and local barometric pressure. Lo and Hp were then determined with a tape measure. The test range for Lo was 20.3-67.3 cm. C*, needed to calculate resulting G₂₀ values, was based on water temperature and local barometric pressure.

Testing of the side flow distribution plate served to validate predictions of an improved Hp, development of a well-defined circulation cell and enhanced gas transfer potential as indicated by G₂₀. Regarding gas entrainment, tests of the side-flow plate conducted with Lo=30.48 cm and 60.86 cm demonstrated Hp was, respectively, 34.6% and 28.6% greater than that achieved with the standard plate design. Hp varied little with Lo as indicated by least squares regression of Hp versus Lo (N=29). The insensitivity of Hp with changing Lo simplifies the design of oxygenator stilling zone depth and may provide for increases in surface loading criteria which is a factor in determining equipment scale. G₂₀ values established during steady state runs with the side-flow distribution plate were also correlated with Lo based on regression analysis (r²=0.9516). This model is similar in format to a regression equation developed previously for G₂₀ provided by a selected standard plate design (uniform distribution of jets on water distribution plate). Inspection of both regression models reveals the Side-flow G₂₀ exceeds Standard G₂₀ when Lo is greater than 15 cm. Improvements, as a percent, are significant and rise with increasing Lo up to the Lo limit of the laboratory tests (67.3 cm), e.g., when Lo=35.6, 50.8, and 67.3 cm, percent improvements in G₂₀ over the standard design are 38.1%, 57.5% and 73.3%, respectively. G₂₀ is a log function related to the degree of removal of the dissolved gas deficit, (C*−C), by the function: % Removal=(1−e^{-G20}) 100. With Lo=67.3 cm, deficit removal, based on G₂₀, will be 44.97% for the standard plate design and 64.65% for the side-flow case, an improvement of 43.76%. To further quantify the positive effects of the side-flow configuration we simulated LHO performance using the multi-component gas transfer model described earlier. Performance was predicted under a standard set of operating conditions (15 C; DOᵢₙ=8 mg/l) with the number of stages fixed at 6. We adjusted oxygen feed rate until the predicted AE matched target AE values of 70, 75, 80, 85, and 90%. Table 1 summarizes example performance predictions (8 of 20) when Lo was 45.72 cm. The variables followed included required oxygen feed rate (% of water flow), DOₒᵤₜ (mg/l), oxygen transfer rate (lb's/day), TE (lb's/hp·hr) and nitrogen transfer rate (lb's/day).

TABLE 1
Simulated effects of distribution plate
design on LHO performance (Lo = 45.72 cm)

| Plate | | | | | | |
|---|---|---|---|---|---|---|
| Design | Target AE | Gas Feed | DOₒᵤₜ* | Lb O₂/d | TE** | LbN₂/d |
| Standard | 75% | 0.88% | 16.75 | 105.04 | 6.06 | 38.97 |
| Side-Flow | 75% | 1.20% | 19.93 | 143.16 | 8.26 | 53.41 |
| Standard | 80% | 0.74% | 15.86 | 94.41 | 5.45 | 34.56 |
| Side-flow | 80% | 1.01% | 18.72 | 128.74 | 7.42 | 47.40 |
| Standard | 85% | 0.60% | 14.76 | 81.18 | 4.68 | 29.08 |
| Side-flow | 85% | 0.82% | 17.23 | 110.85 | 6.40 | 39.94 |
| Standard | 90% | 0.44% | 13.24 | 62.95 | 3.63 | 21.52 |
| Side-flow | 90% | 0.59% | 15.02 | 84.23 | 4.86 | 28.84 |

*mg/l
**Lb N₂/Hp hr

Note that for a selected AE, LHO's incorporating the side-flow configuration are able to operate at a higher oxygen feed rate, that, in turn, increases all performance indicators. The oxygen transfer rate per day, for example, increased, on average, 35.9% over the oxygen transfer rate predicted for the standard plate design. The benefits shown in Table 1 improved further when Lo was elevated to 76.2 cm. In this case oxygen transfer per day was 46.8% higher than the standard plate application. Combined, simulation data show the side-flow plate design will reduce the hydraulic head required for a selected DOₒᵤₜ or can be used to improve the performance of a sub-surface oxygenator where Lo is fixed. The side-flow design also provides for enhanced nitrogen stripping capabilities.

Biofouling is expected in marine net-pen applications. Coarse spray nozzles have a limited sensitivity to biofouling given relatively large water orifice geometries and high velocity water feeds. Gas transfer occurs primarily across the droplet surfaces after release from the nozzle with some beneficial effects expected at the nozzle during droplet formation and upon impact with the receiving water. In an embodiment, drop diameter produced by the nozzles is in a range of 500-1000 microns. Drop diameter decreases with pressure drop P across a given nozzle following the relationship SMD=1/(p^{1/3}), where SMD is the sauter mean diameter. Pressure drop also influences nozzle flow rate, with flow for a new condition (Q₂) proportional to the ratio of the square of the change in pressure drop over a known condition Q₁, i.e., Q₂=Q₁ (P₂/P₁)². The overall mass transfer coefficient K_{L}a provided by a nozzle for a specific gas is related to the diffusion coefficient D, the time of exposure of a surface element of a drop and drop diameter. The time of exposure, in turn, is related to axial velocity and reactor chamber height. Gas transfer also occurs in the bubble entrainment zone. Empirical data is often used to quantify the positive effects of increasing chamber height and P on K_{L}a or G₂₀. The regression equation developed to calculate G₂₀ for a 2-inch full-cone nozzle is as follows (r²=0.97):

$${G}_{20} = a + b ( tower height , m ) + {c ( H L , \frac{kg}{{m}^{2} s} )}^{2}$$

where a=−0.05, b=0.3025 and c=0.000067.

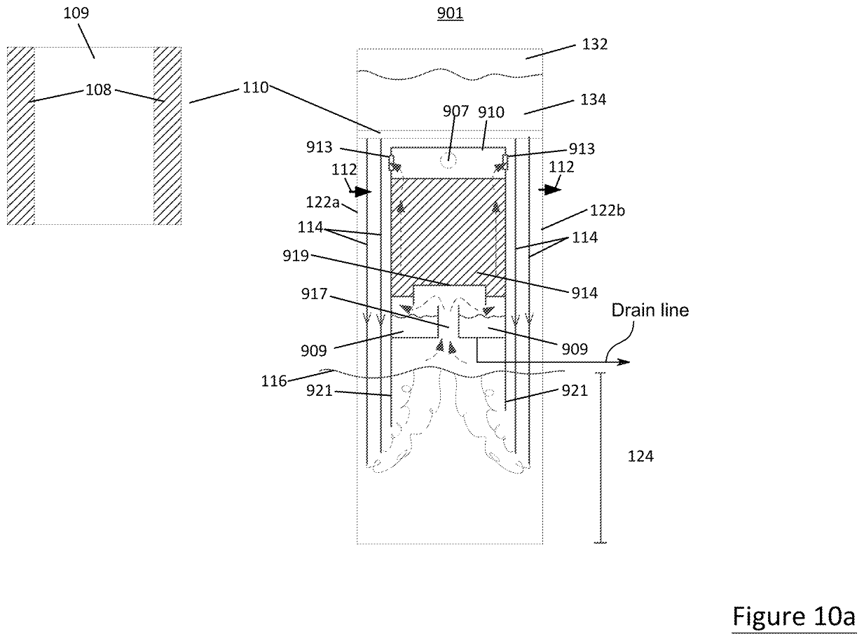

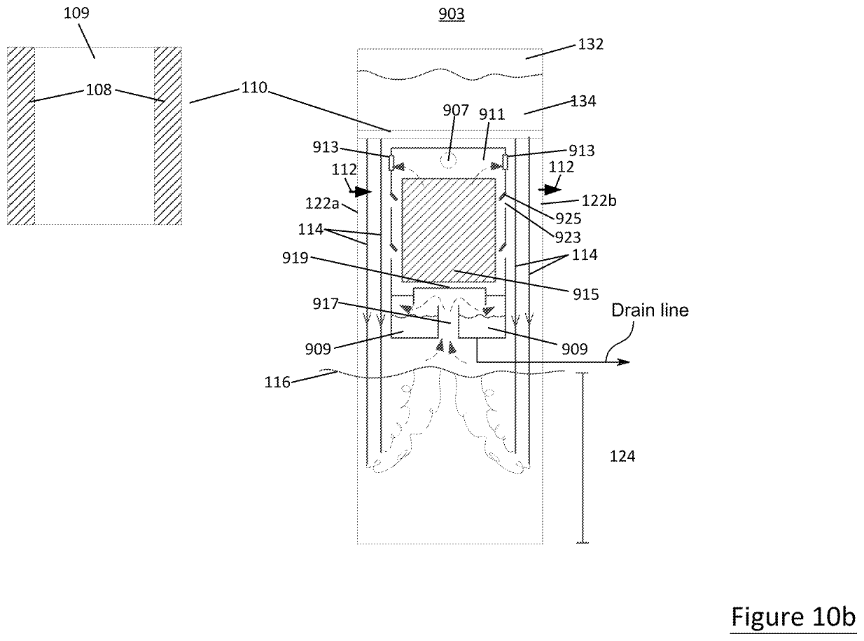

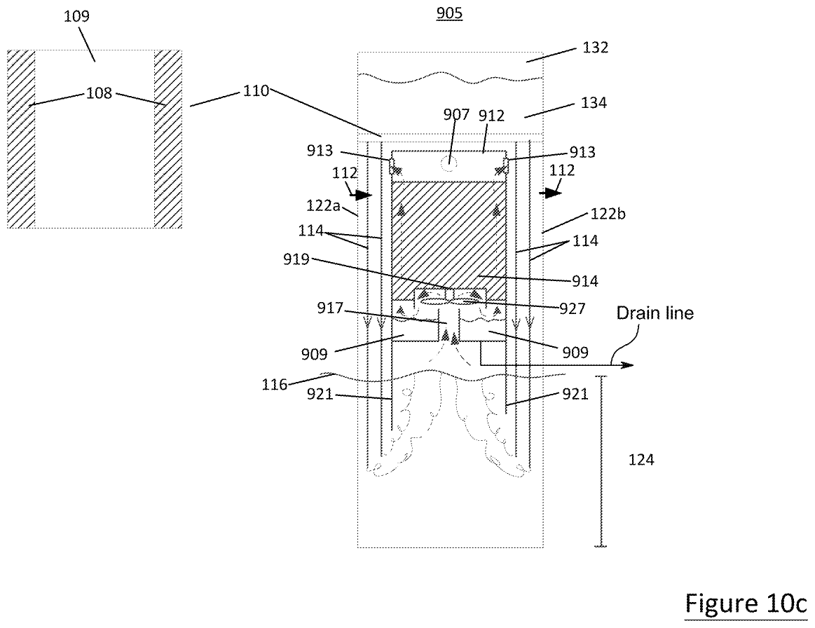

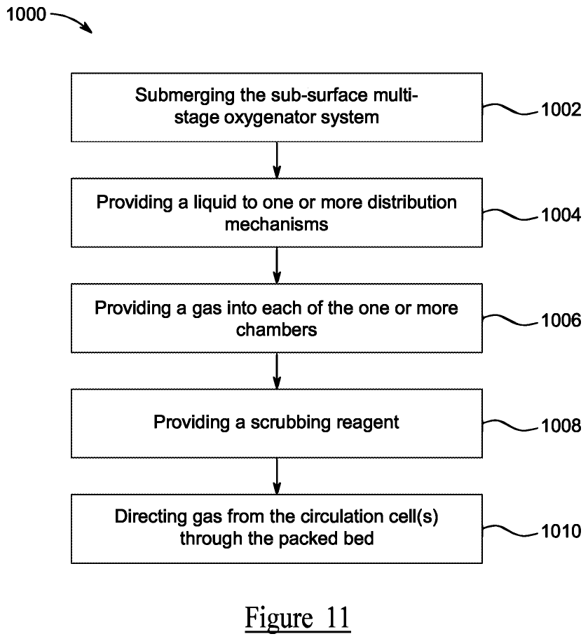

Related to stripping, the concentration of jets along chamber walls and/or vertical baffles make each chamber's head-space region (gas void) available for application of scrubbing component inserts. In one embodiment, scrubbing component inserts can be placed in the head-space region of one or more chambers to perform stripping. FIGS. 10a-10c illustrate three exemplary configurations of chambers 901, 903, and 905 that use scrubbing inserts 910, 911, and 912, all of which are based on the use of short, packed beds (914 or 915) irrigated with a 2N NaOH solution to selectively react away DC desorbed from the jets 114, though it can be appreciated that other solutions besides NaOH can be used in other embodiments. The NaOH solutions can be applied by one or more solution feed lines 907 (e.g. nozzles, liquid distributors), then collected in sumps 909 plumbed to one or more source pumps for recirculation and reuse. Further, the scrubbing solution recirculation loops can be specific to a single stage of the multi-stage oxygenator, or specific to a group of chambers comprising a single oxygenator or specific to a selected group of oxygenators within the aquaculture facility. The pH of the scrubbing solution can be maintained at or above a predetermined value (e.g. 11.4) with additions of NaOH in a feedback loop. NaOH can react with the DC to form sodium carbonate (Na₂CO₃) which has a lower equilibrium pH. A mixture of spent NaOH and Na₂CO₃, collected as an overflow from a scrubbing insert sump 909, can then be regenerated for reuse in a batch process using hydrated lime (Ca(OH)₂). Ca(OH)₂+NaOH generates the products CaCO₃+NaOH. The CaCO₃ produced can be separated from the mixture by gravity and/or filtration before reuse of the NaOH.

Alternatively, packed beds (914 or 915) disposed within the scrubbing inserts 910, 911, or 912 could be irrigated directly with a hydrated lime solution facilitating the reaction Ca(OH)₂+CO₂ to yield CaCO₃. The elevated pH scrubbing solution feed rates to the scrubbing inserts 910, 911, or 912 can represent a small fraction of the water flow through the oxygen absorber given the positive effect of chemical reaction on the gas transfer rate (Equation (1)) as quantified by the enhancement factor β, a ratio of gas transfer with and without chemical reaction. The absorption of DC is considered a pseudo-first-order reaction with regard to DC when the concentration of OH in the bulk scrubbing solution is relatively high and varies little across the scrubbing inserts 910, 911, or 912. β values of between 8 and 250 have been reported when scrubbing DC with NaOH in packed columns, and β values of between 1.2 and 60 have been reported for sphere and bubble columns. In one instance, gas transfer rates increase rapidly with increasing NaOH normality up to about 2N. Further increases in normality can decrease gas transfer rates given concurrent increases in solution viscosity. Gas transfer rates can also decrease as the conversion of NaOH to Na₂CO₃ increases, hence the incorporation of a feedback control loop which can regulate NaOH additions based on scrubber solution pH. Scrubber performance can also be enhanced by elevating packing irrigation rates, gas feed rates, and with elevated scrubber solution temperature. It is understood that the scrubbing solutions used will attempt to reach an equilibrium with the head-space gases following Equations (1)-(5), including oxygen. Accordingly scrubbing solutions can in some cases become oversaturated with oxygen, such as the chambers close to the gaseous oxygen feed point (e.g., chamber 101 of oxygenator 100). Therefore scrubbing solutions sumps and other recirculation loop components outside of the oxygenator shell can be designed to minimize or eliminate exposure of the solution to the local atmosphere so as to stop oxygen losses from the system due to desorption.

FIGS. 10a-10c show that each chamber 901, 903, and 905 has a dedicated NaOH solution feed line 907 and sump 909 drain line that, in this example, pass through a gas tight oxygenator shell. Scrubbing insert 910, 911, or 912 placement ensures (1) no interference with chamber to chamber gas movement (2), no direct contact with jets 114 and (3), no leakage of NaOH into the stilling zone 124. CO₂ scrubbing efficiency, as indicated by changes in DC, is regulated by NaOH solution pH, packing type and depth, NaOH irrigation rate, and head-space gas throughput.

FIG. 10a shows an end view of a chamber 901, which is similar to the chambers 101, 102, 103, 104, 105, 106 from the multi-stage oxygenator 100, but with the addition of a scrubbing insert 910, attached to one or more chamber walls, in the head space region 230 adjacent to, but not in direct contact with, the jets 114. In other words, the scrubbing insert 910 is located underneath the solid region 109 of the distribution plate 110 having no orifices. The scrubbing insert 910 includes a solution feed line 907, vents 913, packed bed 914, chimney 917, chimney cap 919, sumps 909, and skirt 921. The solution feed line 907 releases NaOH into the packed bed 914, which spreads the NaOH solution across various distribution points as it flows downwards towards the sumps 909. In one embodiment, the amount of NaOH solution released by the solution feed line 907 can vary based on scrubber solution pH, which can be known ahead of time and/or measured in real time using a pH sensor and corresponding circuitry. As the jets 114 contact the free water surface 116 and generate circulation cells of bubbles in the stilling zone 124, the scrubbing insert 910 captures the ascending gas bubbles using the skirt 921, which is partially submerged in the stilling zone 124. The skirt 921 can act to separate the ascending gas bubbles from the jets 114. This gas can then pass through the chimney 917 and towards the packed bed 914, rising above a NaOH solution's free surface in the sumps 909. The chimney cap 919 prevents leakage of NaOH into the stilling zone 124. The downward flowing NaOH solution and the upward ascending gas react as they come into contact. Treated gas exits the top of the scrubbing insert 910 via the vents 913, allowing gas recirculation within the area near the jets 114 and immediately below the lower surface of the side-flow distribution plate 110. The ceiling of the scrubbing insert 910 will act to eventually push the treated gas towards one of the vents 913.

FIG. 10b shows an end view of a chamber 903 similar to the chamber 901 discussed with respect to FIG. 10a, but without the skirt 921. Further, the chamber 903 shown in FIG. 10b allows for passive diffusion of head-space gases into and out of the packed bed 915 via openings 923 strategically located on the sides and ends of the scrubbing insert 911. Note that the openings 923 can be configured to prevent jet 114 intrusions into the elevated pH packed bed 915 and sump 909, as well as to prevent NaOH leakage. In one embodiment, this can look like using roofs 925, angled away from the jets 114 and towards the packed bed 915. In this example, to accommodate for the roof 925, the packed bed 915 is slightly smaller than the packed bed 914 from FIG. 10a. Further, for the sake of simplicity, although the chamber 903 has four pairs of openings 923 and roofs 925, only one pair was labelled. It can be appreciated that the number, location, and/or configurations of the openings 923 and/or roofs 925 can vary in other scenarios.

FIG. 10C shows an end view of a chamber 905 similar to the chamber 901 discussed with respect to FIG. 10a, but with the addition of a fan 927, which can be low-power and rated for oxygen service, configured to provide for gas flow through the packed bed 914. In this example, the fan 927 pulls gas generated by the circulation cells of bubbles from near the free water surface 116 through the chimney 917 and towards the packed bed 914 (as indicated by the dashed arrows), The fan 927 is attached to the chimney cap 919 in this exemplary embodiment, though the fan 927 (either the same fan or an additional fan) could be located at other positions in other embodiments. For instance, a second fan can be located on the scrubbing insert's 912 ceiling so as to draw gas up from the lower regions of the packed bed 914. As another example, rotation of the fan 927 can be reversed to draw gas from the head space region of the jets 114, and force this gas downward through the packed bed 914 for release through the chimney 917.

In cases where head space volume available for the scrubbing insert 910, 911, or 912 is limited, the scrubbing insert 910, 911, or 912 could be elevated above, at least partially, the distribution plate 110 by penetration of the distribution plate 110 with a gas tight enclosure designed to not interfere with the distribution plate's 101 active orifices 108.

Incorporation of a scrubbing insert can be implemented in any of the chambers discussed herein, as well as variations thereof. For example, one or more scrubbing inserts can be placed in head-space regions of circular chambers, rectangular chambers, chambers having horizontal baffles, chambers having vertical baffles, et cetera. As can be appreciated, the shape of the scrubbing insert can also vary to accommodate various chamber geometries. Moreover, in an oxygenator having multiple chambers, one or more scrubbing inserts can be placed in a select number of chambers, or in every chamber. Further, it is understood that the irrigated packed beds described could be replaced with granular/porous (dry) reagents capable of capturing head space CO₂. Such reagents include lithium hydroxide, metal-organic frameworks (MOF's), zeolites, mesoporous silica, clay, porous carbons, porous organic polymers (POP's) and metal oxides. Use of the dry reagents can avoid carryover of oxygen in scrubbing solutions as just described, and the scrubbing inserts can be designed with oxygenator stage specific access ports allowing removal of spent reagents and replacement with fresh reagents. Certain spent dry reagents can be regenerated for reuse in a separate treatment step that can include heating and forced air exchange.

FIG. 11 illustrates a flowchart outlining a method 1000, according to one exemplary embodiment. Steps 1002-1006 are the same as steps 902-906, respectively, from method 900. Method 1000 adds the additional capability of being able to perform stripping by utilizing head-space made available by the incorporation of the side-flow distribution plates discussed herein. A scrubbing insert (e.g. scrubbing insert 910, 911, 912) can be placed in the head-space region, and perform stripping on gas released from circulation cells of bubbles using a scrubbing reagent.

Step 1008 is providing a scrubbing reagent to a packed bed (e.g. packed bed 914 or 915). In one embodiment, a solution feed line dispenses the scrubbing reagent (e.g. NaOH, Ca(OH)₂) to the packed bed. The scrubbing reagent can be dispensed near a top portion of the packed bed such that it flows downwards due to gravity. The scrubbing insert can contain a sump located under the packed bed to capture the scrubbing reagent and prevent it from leaking into the stilling zone. The scrubbing insert can also include a chimney cap to prevent the scrubbing reagent from leaking into the stilling zone in areas that the sump does not cover. In one embodiment, the packed bed can be irrigated directly with a scrubbing reagent (e.g. hydrated lime).

Step 1010 is directing gas from the circulation cells of bubbles through the packed bed. In one embodiment, this is done by placing the scrubbing insert directly above the location where the gas from the circulation cells of bubbles are generated. As the gas floats upwards, it can flow into the scrubbing insert and through the packed bed. A skirt can also be used to direct the gas towards the packed bed, and kept away from any jets. In one embodiment, one or more fans can also be implemented to push and/or pull the gas through the packed bed and through the vents. In one embodiment, step 1010 can be performed before or at the same time as step 1008.

When the gas from step 1010 is directed through the packed bed, the gas reacts with the scrubbing reagent provided in step 1008 to strip CO₂ from the gas. As this gas reacts and eventually exits the packed bed, the gas can flow through the vents and recirculate to nearby jets. This gas can be directed to flow through the vents via the scrubbing insert's ceiling, which will act to contain the gas and eventually direct it towards the vents, and/or a fan. Alternatively, as previously mentioned, a fan can act to draw gas near jets in through the vents, and through the packed bed.

While the description above focuses on a non-pressurized oxygenator design, the systems and methods discussed herein can be implemented as a vacuum degasser or a medium pressure (side-stream) oxygenator. The side flow distribution plates can improve AE and TE by reducing column vacuum requirements, thereby lowering operating costs and providing savings in oxygen feed requirements.

In one embodiment, a vacuum degasser operating with a side-flow distribution plate can have water flooded over the distribution plate where the container holding the water and the distribution plate is isolated from the atmosphere (e.g. by a blind flange covering an open top of a trough). Feed water jets created by the distribution plate can drop into a stilling zone of a chamber, then exit the chamber via a flanged pipe connected to a bottom portion of the chamber to a water pump. The free surface of the stilling zone can be maintained at a level providing a target Lₒ by placement of a water jet exhauster at an appropriate elevation above a bottom flange plate of the chamber, the bottom flange plate having no discharge slots. An exhauster can pull off-gas out of the last chamber of a multi-stage reactor, thus causing headspace gas movement, sequentially, from the oxygen introduction point (i.e. first chamber) to the last chamber via individual chamber gas ports. These ports can be located above the free surface of the stilling zone.

Water jet exhauster performance drops with flooding, which keeps the free surface of the stilling zone from changing with adjustments in gas or water feed rates. The exhauster is served by a dedicated stream of high-pressure water that transfers the energy required to both extract and carry away off-gas from the last chamber. High vacuum levels within the chambers can be generated by a water pump coupled with a lower column discharge flange. The pump can pull water through an inlet throttle valve without air entrainment as the chamber's internal free surface is fixed by the water jet exhauster. The water pump can also provide a discharge pressure needed to deliver treated water to its use point. Vacuum and water flow rates can be adjusted by changes in both the inlet and pump discharge throttle valves. This configuration of the reactor's chambers, as well as the positioning of the water jet exhauster directly at the elevation point providing the desired Lₒ, eliminates the need for a down-stream off-gas separator, prior to pumping.

The systems and methods discussed herein may also be embodied in a pressurized multi-stage oxygenator (MHO) that uses a side-flow distribution plate. Water can be forced into a sealed column's flooded distribution plate zone (i.e. above the side-flow distribution plate), via pump action, then drop as jets to the free surface of the stilling zone. The water provides the quiescent conditions needed for bubble-water separation prior to water release via a valved discharge port. Partially restricting this valve allows column gage pressures to rise to target levels as provided by the feed water pump. Oxygen can be metered into a first chamber of a multi-chamber system. Off-gas can exit the system via a float valve coupled to the final chamber. The valve position can regulate off-gas release based on a decrease in stilling zone depth caused by oxygen feed rates that exceed oxygen absorption rates. As in the vacuum degasser, gas release initiates gas movement from the first chamber, sequentially, to the last chamber via individual gas ports positioned in chamber walls above the free surface of the stilling zone. Chamber walls can extend well below the bubble entrainment zone to ensure bubbles do not escape individual chamber boundaries. Chamber walls are also gas-tight where chamber walls intersect the underside of the water distribution plate, as well as the system shell.

Field trials and follow-on computer simulations have shown that the new side-flow distribution plate configuration improves the AE and TE of sub-surface oxygenation equipment as well as alternative reactors employing perforated distribution plates. The alternative reactors include multi-stage side-stream oxygenation equipment operated at positive gage pressures. Sub-surface applications in net pens and semi-contained net pens are very attractive given the relative ease of exploiting hydrostatic pressures available in deep water rearing locations both within and outside of pen boundaries. Passive pressurization of the reactor accelerates oxygen transfer providing for effluent DO well above local air saturation concentrations thus minimizing equipment scale as well as required energy input.

In an embodiment, the dissolved gas deficits that drive gas absorption rates can be manipulated within the boundaries of the gas-tight reactors by elevating the mole fraction, X_{O2}, of oxygen above that of the local atmosphere (0.20946), as well as by increasing the pressure, P_{T}, at which gas transfer occurs i.e., the saturation concentration of a gas in solution (C*) is determined by its partial pressure in the gas phase (Equations (4) and (5)). For example, increasing P_{T} from 1 atmosphere to 3 by submergence of the reactor at 12° C., and X_{O2}=0.6, increases C* from 30.85 to 93.42 mg/l. If the ambient DO is 5 mg/l, the corresponding dissolved gas deficit and resulting gas transfer rate is then increased 3.42-fold (Equation (1)). The total absolute pressure within the reactor, is related to the local atmospheric pressure, BP (mmHg), salinity and depth of submergence (Z, m) i.e., P_{T}=BP+pgZ. For example, at a salinity of 35 ppt, pg=75.8 mmHg/m, setting depth Z to 37 m, with a local BP of 760 mm Hg, P_{T} is calculated to be 3564.6 mmHg. The resulting gage pressure of 280.46 cm Hg (54.2 psig) is significant and provides for side stream treatment with blending, given the reactors effluent DO, will be well in excess of the local air saturation concentration. This has been achieved without the pumping required to operate surface based pressurized packed columns and venturi-based oxygenation equipment.

In the example above, the mole fraction X of O₂ was set at 0.6. By design, this term decreases below the feed gas composition of X_{O2} (0.9-1.0) as off-gas moves from the first to last stage of a multi-stage reactor. The extent of the change is related to oxygen feed rates, K_{L}a, temperature, DO, nitrogen stripping and hydraulic loading and pressure. These changes are followed, stage by stage, with proprietary software that incorporates a group of finite-difference mass-transfer calculations. Overall reactor performance is also summarized by the software including effluent DO, TGP, oxygen transfer rate (lb/d), AE, TE, and transfer costs. This software was used to explore the performance characteristics of a sub-surface oxygenator (8-stages) operating at each of four depths—0 feet, 24 ft (7.3 m), 65 feet (19.8 m) and 107 feet (32.6 m). The effective water jet or spray fall zone (L₀) was fixed, in all cases, at 30 inches (0.762 m). Simulations were performed with gas transfer coefficients established previously for both a selected standard and high efficiency (side-flow) water distribution plate. Conditions selected include a temperature of 12° C., an inlet DO of 5 mg/l, a BP of 760 mm Hg, a salinity of 35 ppt, a feed gas purity of 93% and a power cost of $0.15/kWhr. Influent DN was assumed to be at surface saturation levels calculated based on solubility coefficients. The water flow rate through the reactor was fixed at 2000 gpm based on an analysis of a net pen design that used multiple pumps to deliver a total feed water flow of about 95,000 gpm from a depth of about 40 m. In this example, sub-surface reactor flows represent just 12.6% of the total flow entering the pen. The maximum daily average oxygen demand was calculated given the maximum projected feed rate as per standard formula. Peak rates typically occur in the late afternoon and can represent 1.4 times the daily average rate. In this example the daily average and peak rate was estimated to be 2,769 kg O₂/d and 3,877 kg O₂/d, respectively. Environmental data indicates ambient feed water DO, in net pen production sites, can be as low as 5 mg/l. This concentration is generally considered the lower acceptable limit for salmonids and so under these worst-case conditions oxygen demand of the cohort is not reduced by natural sources of oxygen and must then be provided by the oxygenation system. Calculated DO addition rates to the pen feed water, after blending with oxygenator effluent, are then 5.3 and 7.5 mg/l, respectively, for the maximum daily average and peak demands. Corresponding oxygenator effluent DO requirements, prior to dilution, are 47.3 and 64.3 mg/l. These concentrations lie beyond the economical capability of non-pressured oxygenation equipment.

Table 2 summarizes the predicted performance of the exemplary oxygenator corresponding to the above example versus operating depth at two selected AE values (75% and 92%). Again, simulations were based on two water distribution plate configurations: a selected standard design and the side-flow high efficiency design of the present embodiment. Note that effluent DO, oxygen transferred/d and TE rise dramatically as depth increases from 0 to 107 feet. Effluent DO, for example (side-flow case), is elevated 4.17-fold from 17.9 to 92.9 mg/l when AE was set at 75%. Effluent DO's in both plate configurations satisfy projected peak supplementation requirements but enhanced performance is provided by the side flow distribution plate design. Predicted TE values are extremely high reaching, in this series, 30.44 lb O₂/hp-hr or 22.7 kg/kW-hr. This value is well above the range previously established for land based LHO's (5.5 kg/kW-hr) as well as pressurized packed columns (1.0 kg/kW-hr) and venturi-based injectors (0.5 kg/kW-hr). To further explore the benefits of sub-surface operation, Table 2 performance predictions were used to establish the effects of operating depth on required water flow rate through the reactor, power requirements and reactor cross-section requirements (scale) needed to provide a new target for oxygen transfer of 987.5 lb O₂/d. All of this, including relative values, is summarized in Table 3. Note that reactor flow requirements drop dramatically with increasing depth. In this example, flow, distribution plate area and power requirements at 107 feet, represent just 9.1%, 9.1%, and 3.6%, respectively, of values required at the sea surface. Further, the pumping power required to establish the gage pressure associated with 107 feet of submergence has been reduced from 70.31 to 2.53 hp.

Table 2 below is a summary of oxygenator performance versus depth of submergence when operating at an oxygen absorption efficiency of 75% and 92%. Calculations were based on use of both a selected standard and side flow liquid distribution plates. Water flow rate is 2000 gpm in all cases. G/L is the feed gas to liquid ratio expressed as a percent.

| | | | | | |
|---|---|---|---|---|---|
| | Effluent | Pounds O2 | Transfer | O2 Absorption | |
| Depth | DO | Transferred | Efficiency | Efficiency | G/L |
| (feet) | (mg/L) | (LB's/d) | (LB's/Hp-hr) | (%) | (%) |

Standard Correlation:

| | | | | | |
|---|---|---|---|---|---|
| 0 | 10.00 | 120.0 | 1.73 | 92.2 | 0.44 |
| 24 | 21.82 | 403.8 | 5.85 | 92.2 | 1.48 |
| 65 | 40.53 | 853.2 | 12.31 | 92.1 | 3.13 |
| 107 | 59.68 | 1312.9 | 18.94 | 92.1 | 4.82 |
| 0 | 13.71 | 209.2 | 3.02 | 75.2 | 0.94 |
| 24 | 25.15 | 483.7 | 6.97 | 75.0 | 2.18 |
| 64 | 44.30 | 943.7 | 13.61 | 75.0 | 4.25 |
| 107 | 63.85 | 1413.1 | 20.38 | 75.2 | 6.35 |

Side-flow Correlation:

| | | | | | |
|---|---|---|---|---|---|
| 0 | 15.19 | 244.6 | 3.53 | 91.9 | 0.67 |
| 24 | 30.07 | 601.9 | 8.68 | 92.0 | 2.21 |
| 65 | 57.97 | 1271.8 | 18.35 | 92.2 | 4.66 |
| 107 | 86.60 | 1958.5 | 28.25 | 92.2 | 7.18 |
| 0 | 17.94 | 310.7 | 4.48 | 75.0 | 1.40 |
| 24 | 34.97 | 719.7 | 10.38 | 75.1 | 3.24 |
| 65 | 63.59 | 1407.0 | 20.29 | 75.1 | 6.33 |
| 107 | 92.87 | 2109.8 | 30.44 | 75.1 | 9.50 |

Table 3 below is a summary of relative water flow rate, pumping power and reactor cross-sectional area (scale) requirements to achieve an oxygen delivery rate of 987.2 lb O₂/d versus operating depth. Performance data was gleaned from Table 2. (T=12° C.; DO in=5 mg/l; combined pump and motor efficiency=0.6, 8-stages, 30-inch spray fall, salinity=35 ppt; gas oxygen purity=93%, standard plate data only when operating at an oxygen absorption efficiency (AE) of 92%.) Relative flow (fraction), relative power (fraction) and relative area (fraction) are calculated as a ratio of the variable at 0 feet depth.

| | | | | | Power | | |
|---|---|---|---|---|---|---|---|
| | | | Power | | Required | | |
| | Required | Relative | Required | Relative | @ | Area | Relative |
| Depth | Flow | Flow | @ Depth | Power | Surface | Required | Area |
| (feet) | (gpm) | (Fraction) | (Hp) | (Fraction) | (Hp)* | (ft²) ** | (fraction) |
| 0 | 16,453 | 1.000 | 27.72 | 1.00 | 27.72 | 365.6 | 1.000 |
| 24 | 4,889 | 0.297 | 8.24 | 0.143 | 57.67 | 108.6 | 0.297 |
| 65 | 2,314 | 0.141 | 3.89 | 0.058 | 67.26 | 51.4 | 0.141 |
| 107 | 1,504 | 0.091 | 2.53 | 0.036 | 70.31 | 33.4 | 0.091 |

*Assumes pumping is required to achieve same pressure as that provided by depth of water when units are submerged- - surface operation.
** This is the cross-sectional area of the water distribution plate required to handle the projected water flow rate when operating at a hydraulic loading rate of 45 gpm/ft².

Embodiments of the present disclosure include sub-surface designs, suspended at set depths via anchoring, moorings, ballast and reserved buoyancy or a combination of such. Such embodiments may be located within semi-contained net pens, outside of semi-contained net pen enclosures with placement adjacent to existing suction lines serving one or more feedwater pumps, and outside of semi-contained pens but coupled directly to individual feed water suction lines without potential for side-stream treatment. That is, some embodiments rely on submersible, ultra-low head axial flow pumps for delivery of the design flow rate. Other embodiments take advantage of existing feed water pump suction to pull water through the oxygenator thus eliminating the need for additional pumping hardware.

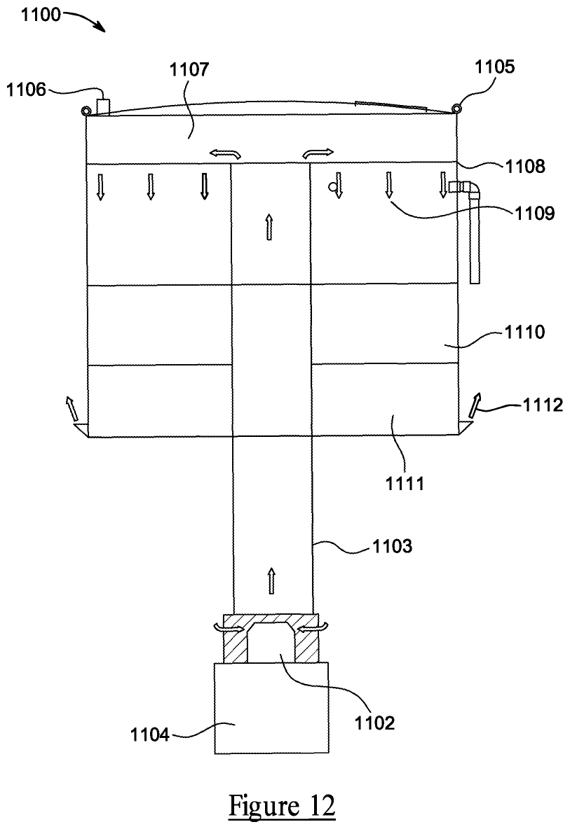

FIG. 12 shows a side view of a reactor 1100 designed for placement at depth within net pen and semi-contained net pen enclosures. As shown, the system consists of 3 major components: a hooded reactor 1101 receiving water and commercial oxygen, an axial flow pump 1102 coupled to a water delivery riser 1103 and a ballast system 1104 responsible for keeping the reactor submerged and stable when lowered into position. A cable connection 1105 connects to cabling (not shown) to raise and lower the reactor assembly. The cabling may also support motor wiring, oxygen supply hose, snorkel tube with valve 1106 and instrumentation signal wire. Motor torque requirements must also be considered. In operation, the snorkel tube valve is opened allowing the reactor to purge entrapped air as the reactor assembly is lowered into a submerged position. At the target depth of operation, the snorkel tube valve is closed, and the pump is activated. Water (2000 gpm) is forced into the flooded head space 1107, then flows with a pressure drop across the distribution plates 1108, through the flooded spray zone 1109, stilling zone 1110 and collection zone 1111 before exiting the reactor via the circumferential discharge slot 1112. The circumferential discharge slot 1112 acts to mix product water with net pen bulk flows.

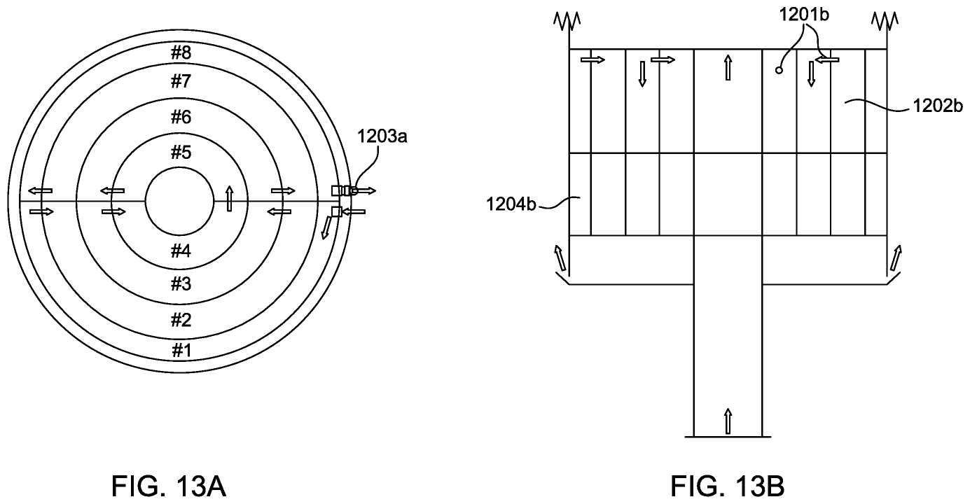

At this point in the startup procedure, oxygen is directed into Stage 1 of the 8-stage reactor as described in detail in FIGS. 13a and 13b. Oxygen moves via gas ports 1201b through the spray zone 1202b of stages 1-8 down to an elevation equal to that of the open end of the off-gas vent 1203a coupled to the end wall of chamber 8. Water jets develop in the head space created, and off-gas is released on a continuous basis from the vent 1203a. Note that the stilling zone 1204b allows for entrained bubble formation and hold-up to facilitate gas transfer but also prevents gas bubble wash out. An access hatch on the upper end of the reactor allows for inspection/cleaning of the distribution plates or nozzles when not in use. Oxygen feed rate will be regulated and measured at the surface based on DO demand. This process could be automated that may include motor speed control and ambient water DO sensors coupled to electrically operated gas regulating valves. Treated water exits via a continuous circumferential or intermittent slot 1112 at the base of the reactor as shown in FIG. 12. The discharge is routed away from the pump intake towards the sea surface to prevent water recycling via the slot shown or a piped manifold/distributor. Ballast requirements for reactor stability at the lower end of the unit, and ballast position below the reactor bottom plate, need to be engineered so as to consider expected current forces, materials of construction and the gas void that is established in the water jet zone. Likewise, pump intake screening, or filtering, requirements will be related to solids loading. In an embodiment, this is an open reactor design with about a 4′ pressure drop across the reactor. Accordingly, the reactor shell is not acting as a high pressure vessel that must be capable of handling the hydrostatic pressures generated by sub-surface operation. The embodiment shown in FIG. 12 is flexible in scale and could be produced to handle a wide range of water flow rates and oxygen supplementation rates. The overall height of the reactor portion of the assembly may remain consistent with FIG. 12 but the diameter of the reactor, riser pipe diameter, orifice schedule and ballast may be varied to match hydraulic loading.

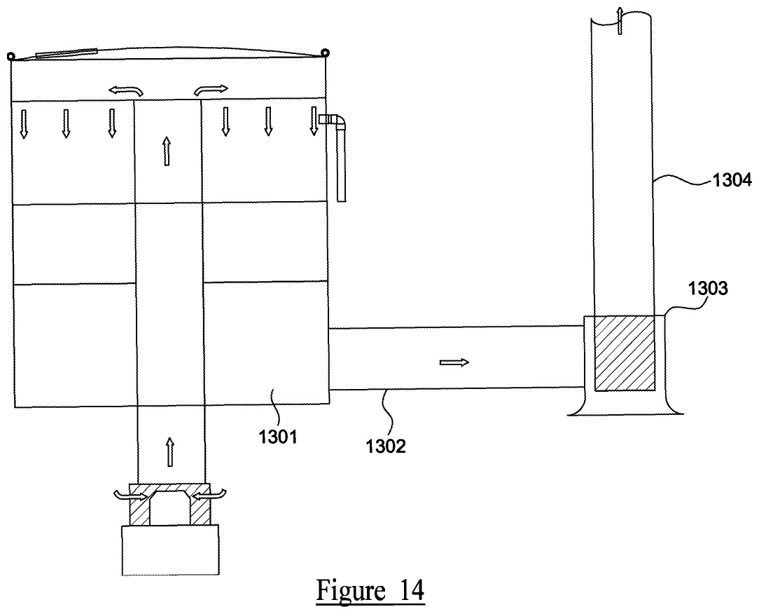

FIG. 14 shows a side view of the FIG. 12 assembly modified to allow positioning at depth, outside the boundaries of a semi-contained net pen. Again, oxygen is directed through the 8-stage reactor with a water jet zone. In this case, the depth of the un-baffled water collection zone 1301 has been increased to accommodate delivery of product water, via a pipe stub 1302, to the shrouded intake 1303 of the net pen's feed water pump 1304. This configuration eliminates the FIG. 12 circumferential discharge slot and instead relies on dilution and delivery of oxygenated water via net pen feed water pumping action. As described above, the number of units applied can be varied, and output could be scaled up or down to meet target delivery rates. Coupling the reactor directly to the existing suction line provides a simple means of neutralizing torque generated by the axial flow pump. Alternatively, a centrifugal pump can be used to minimize torque effects by mounting the pump with its discharge directed into the riser serving the distribution plate with the pump motor and impeller operating at 90 degrees offset from the vertical axis of the reactor.

FIG. 15 shows a side view of the FIG. 12 assembly modified to exploit the suction lift potential of the semi-contained net pen feed water pumps to eliminate the need for a separate low head pumping step. Here, a net pen pump 1401 pulls water into the reactor's inlet ports 1402 present on the surface of the upper domed hood 1403 after passing through intake screening or filter 1410. Water is then directed through a perforated distribution plate 1404, water jet zone 1405, stilling zone 1406 and water collection zone 1407, prior to entering the open end of the pump suction line 1408. Reactor stages and oxygen flow paths are the same as those shown in FIG. 13. The off-gas vent port 1409 responsible for maintaining the free surface of the water jet zone relies, in this embodiment, on a float activated gas release valve coupled to a gas snorkel extending just beyond the free surface of the ocean. This new configuration is required given that the gage pressure of the water spray zone is lower than the hydrostatic pressure present at depth but is higher than that present at the sea surface. Cabling and ballast requirements for stabilization of the reactor will be related to pump suction line geometry/materials of construction as well as local hydrodynamic conditions, e.g., water currents. Head requirements for operation will be added to the existing feed water pump demands which may require an upgrade in power or impeller design. Reactor scale can be adjusted to match the hydraulic loading of the feed water pump.

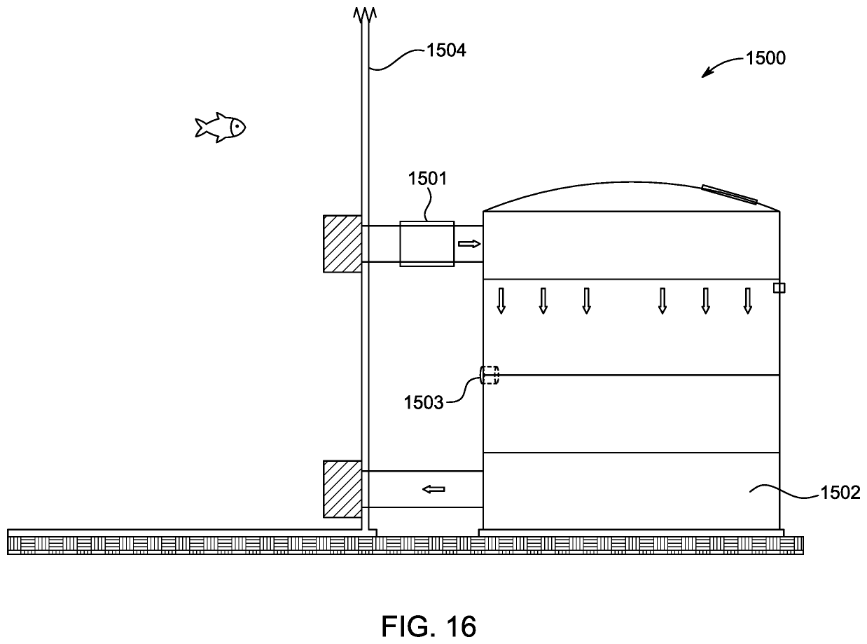

FIG. 16 gives a side view of the FIG. 12 reactor modified to operate as a side-wall reactor exploiting hydrostatic pressure provided by large diameter, deep, RAS circular rearing tanks. In this embodiment, the outer shell of the reactor is a pressure vessel operating via application of an angle drive low-head axial flow pump 1501. The angle drive allows for use of an air-cooled motor eliminating heat addition to the water treated. Reactor internals are the same as those of FIGS. 12 and 13 but in this case the water collection zone 1502 has been increased to accommodate use of the screened water return line. Intake and return line orifices could be oriented to encourage tank mixing. As in the FIG. 15 configuration, the off-gas vent coupled to stage 8 is a float activated gas release valve 1503.

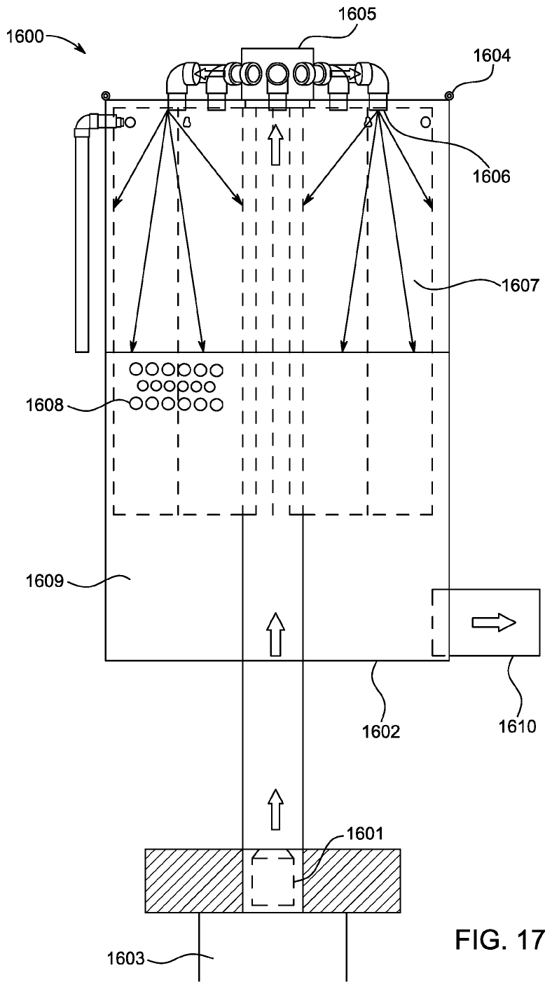

FIG. 17 shows the major components of a spray nozzle reactor 1600 designed to attach directly to the net pen suction line, like the embodiment shown in FIG. 14. In this embodiment, the spray nozzle system functions as the liquid distribution mechanism, instead of a perforated distribution plate. The system's major components are a hooded reactor receiving water and commercial oxygen, an axial flow pump 1601 coupled to a water delivery riser 1602 and a ballast system 1603 responsible for keeping the reactor submerged and stable when lowered into position. A surface cable connection 1604, as in the distribution plate designs, connects to cabling used to raise and lower the reactor assembly as well as to support motor wiring, oxygen supply hose, snorkel tube and instrumentation signal wire. As in previous embodiments, motor torque requirements must also be considered. In operation, the snorkel tube valve is opened allowing the reactor to purge entrapped air as the reactor assembly is submerged into position. At the target depth of operation, the snorkel tube valve is closed, and the pump is activated. Water is forced into the manifold 1605 serving the nozzles 1606, then flows from the nozzles 1606 through the flooded (gas void) spray zone 1607, stilling zone 1608 and collection zone 1609 before exiting the reactor via the pipe stub 1610. The pipe stub 1610 acts to mix product water with net pen pump suction line flows.

Spray nozzles are available in a variety sizes and materials including stainless steel. Total nozzle capacity is easily adjusted by changing the pressure drop, nozzle diameter and number of nozzles used in a particular design. Excessive wave action or currents may create problems in sub-surface applications given the potential for inducing wall flow via tilt or gas pumping action within individual reaction chambers. Accordingly, distribution mechanisms are to be selected based on expected wave and current forces.

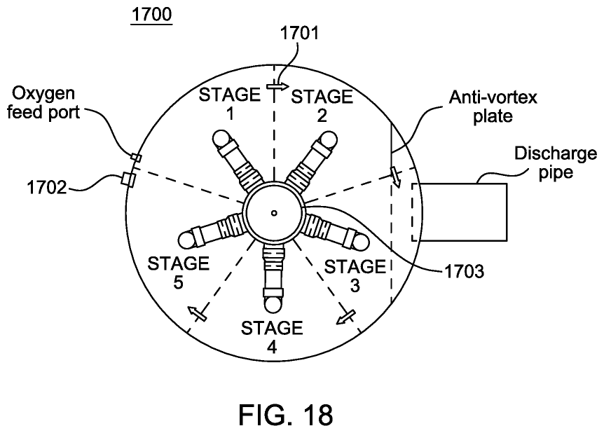

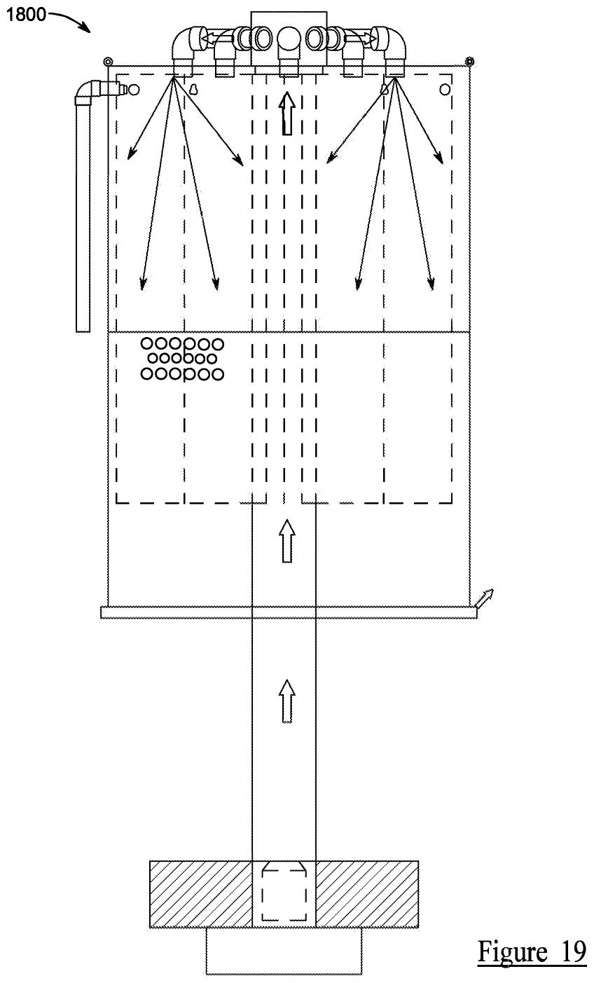

During the startup procedure, oxygen is directed into Stage 1 of the reactor. For example, an embodiment with a 5-stage reactor 1700 using nozzles, similar to the reactor 1600 of FIG. 17, is shown in FIG. 18. Oxygen moves via gas ports 1701 through stages 1-5 to an elevation equal to that of the open end of the off-gas vent 1702 coupled to the end wall of chamber 5. Water droplet sprays will then develop in the head space (gas void), and off-gas is released on a continuous basis from the vent. Note that, as in the distribution plate designs, the stilling zone allows for entrained bubble formation and hold-up to facilitate gas transfer but also prevents gas bubble wash out. An access hatch 1703 on the upper end of the reactor's inlet manifold allows for inspection/cleaning of the piping/nozzles when not in use. Nozzles can also be flanged for quick removal and inspection. Oxygen feed rate will be regulated and measured at the surface based on DO demand. This process could be automated with equipment that may include motor speed control and ambient water DO sensors coupled to electrically operated gas regulating valves. Ballast requirements at the lower end of the unit, positioned below the reactor bottom plate, need to be engineered so as to consider expected current forces, materials of construction and the gas void that is established in the head space or jet zone. Likewise, pump intake screening or filter requirements will be related to solids loading. Regarding materials of construction, the reactor shell is not acting as a high pressure vessel that must be capable of handling the hydrostatic pressures generated by sub-surface operation or pumping action, as the embodiments of FIGS. 17 and 18 relate to an open reactor design. The embodiment of FIG. 18 is flexible in scale and could be produced to handle a wide range of water flow rates and oxygen supplementation rates. The overall height of the reactor portion of the assembly may remain consistent with FIG. 18 but the diameter of the reactor, riser pipe diameter, nozzle size and ballast may be varied to match hydraulic loading. In an exemplary aspect illustrated in FIG. 19, the water delivery pipe rises up through the center of the reactor and is plumbed to the submersible pump positioned below the reactor at depth. This acts to transfer the load of the attached pump and ballast to the reactor shell via the internal chamber baffles and lowers the reactors center of gravity providing a righting couple which tends to rotate the reactor back to its original position after being rotated by, for example, local water currents, i.e., the condition for stability of bodies (reactors) completely submerged in a fluid (water) is that the center of gravity of the body must be below the center of buoyancy. The center of buoyancy of the reactor is at the centroid of the displaced volume of fluid (reactors gas void) and it is through this point that the buoyant force acts in a vertical direction. The weight of the reactor acts vertically downward through the center of gravity.

FIG. 19 shows the spray nozzle reactor designed for positioning at depth within the confines of the net pen or semi-contained net pen. In this embodiment, as in the reactor 1800 shown in FIG. 12, treated water exits via a continuous circumferential or intermittent slot 1801 at the base of the reactor. The discharge is routed away from the pump intake towards the sea surface to prevent water recycling. Alternatively, the combined discharge from the reactor could be combined and directed through a perforated manifold extending in one or several directions from the reactor to distribute and mix the treated water with net pen water.

While the reactors 1600 and 1800 illustrated in FIGS. 17 and 19 draw water in from beneath via an axial flow pump (1601 in FIG. 17), other methods of drawing in water are possible without departing from the scope of the present disclosure. For example, a pump may be disposed above the reactor and/or at the surface of the water in order to push water down into the reactor from above. In this reactor design the water enters the top of the reactor via its dome or a series of nozzles, such as the nozzles illustrated in FIG. 17. This avoids any limitation to the depth at which a pump can operate due to pump shaft seals. This reactor design also advantageously allows the pump to be “non-submersible,” which further reduces cost and facilitates maintenance and repair. The pump may be connected to the reactor via a hose or pipe as one of ordinary skill in the art would recognize.

Furthermore, the nozzles may be positioned to spray water from the bottom of the head space portion of the reactor in order to increase droplet residence time for enhanced gas transfer and to minimize small bubble formation at the boundary between the internal head space and the free surface of the water. This limits the potential of bubbles being swept out of the reaction chamber in, for example, salt water applications. Numerous other variations are also possible as one of ordinary skill will recognize.

Table 4 compares the standard, side flow and spray nozzle effluent DO's, oxygen transfer rate (OTR), transfer efficiency (lb O₂/Hp-hr), corresponding gas-liquid ratio at the inlet, and the percent of the required OTR provided by the individual system/condition. The relative performance of the spray nozzle systems was determined by extrapolating mass-transfer coefficients (G₂₀) for a test 3-inch nozzle. This information was then used to calibrate existing sub-surface oxygenator software allowing for performance predictions for the reactor at depths of 24, 65 and 107 feet. Operating conditions were the same as those used to generate the Table 2 and Table 3 data described above. Table 4 compares performance with reduced scale (1000 gpm) distribution plate reactors (six stages) using a selected standard and side flow-based mass transfer coefficients when operating with an oxygen absorption efficiency of 90%. The values in Table 4 indicate that the standard mass transfer correlation at 107 feet, the side-flow mass transfer correlation at 65 and 107 feet, and the spray nozzle mass transfer correlation at 65 and 107 feet all met or exceeded the required OTR. Note that the spray nozzle system provides the highest effluent DO (96.5 mg/l), OTR (1097.9 lb's/d) and reserve capacity (222.4%), but increased power requirements reduced transfer efficiency well below the values provided by the perforated side-flow distribution plate designs. The spray nozzle transfer efficiency values at 65 and 107 feet are very good (4.33 to 6.67 lb O₂/hp-hr) and will become larger as the allowable AE drops from 90%, for example, to 75%. The pumping power required for the spray nozzle and perforated plate systems are about 7 and 1.5 hp, respectively, assuming a combined pump and motor efficiency of 70%. These values are low and reasonable for duty at sea. Maintenance requirements for the spray nozzle-based oxygenators are expected to be lower than the perforated plate designs given the large orifice size and ease of nozzle access provided by the external manifold shown in FIG. 18. Further, the spray nozzle systems should be less sensitive to wall-flow issues related to current-induced reactor tilt.

Table 4 below shows a summary of sub-surface multi-stage oxygenator performance versus depth of submergence when operating at an oxygen absorption efficiency of 90%. Calculations were based on use of a selected standard distribution plate, the side-flow distribution plate and spray nozzle liquid distributor. T=12 C, DOᵢₙₗₑₜ=5 mg/l, head loss for both standard and side flow designs=4′, head loss for spray nozzle system=19′, water flow Rate=1000 gpm. Required O₂ transfer rate is 493.8 Lb's/day.

| | | | | | |
|---|---|---|---|---|---|
| | Effluent | Pounds O₂ | Transfer | % of Target | |
| Depth | DO | Transferred | Efficiency | Daily Rate | G/L |
| (feet) | (mg/L) | (LB's/d) | (LB's/Hp-hr) | (%) | (%) |

Standard Correlation*:

| | | | | | |
|---|---|---|---|---|---|
| 24 | 22.18 | 206.3 | 5.95 | 41.8 | 1.55 |
| 65 | 40.72 | 428.8 | 12.37 | 86.9 | 3.20 |
| 107 | 60.01 | 660.4 | 19.05 | 133.8 | 4.95 |

Side-flow Correlation*:

| | | | | | |
|---|---|---|---|---|---|
| 24 | 30.52 | 306.4 | 8.84 | 62.0 | 2.30 |
| 65 | 58.43 | 641.5 | 18.51 | 129.9 | 4.80 |
| 107 | 87.17 | 986.5 | 28.46 | 199.8 | 7.40 |

Spray Nozzle Correlation**:

| | | | | | |
|---|---|---|---|---|---|
| 24 | 33.15 | 338.0 | 2.05 | 68.5 | 2.54 |
| 65 | 64.40 | 713.2 | 4.33 | 144.5 | 5.40 |
| 107 | 96.45 | 1097.9 | 6.67 | 222.4 | 8.25 |

*Six-stage reactor
**Five-stage reactor

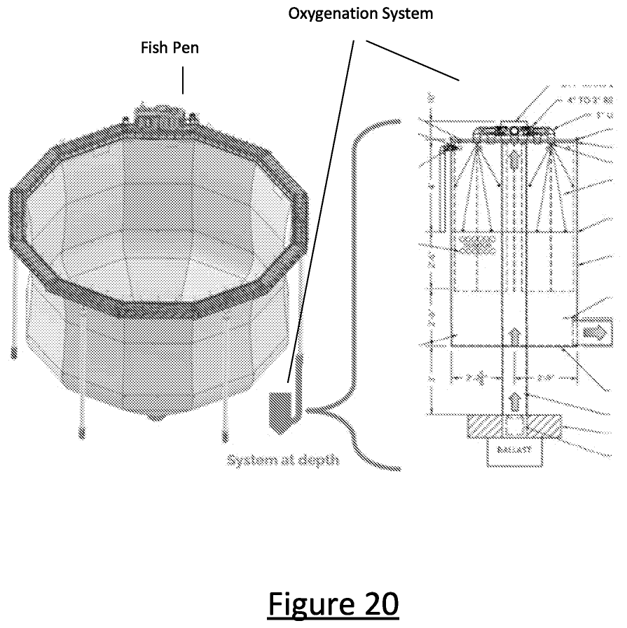

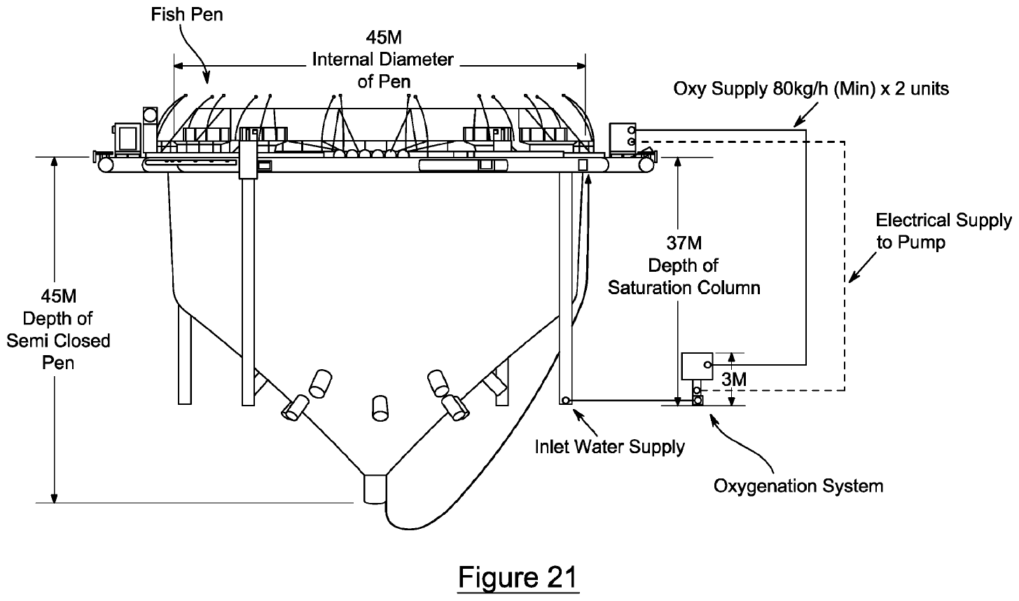

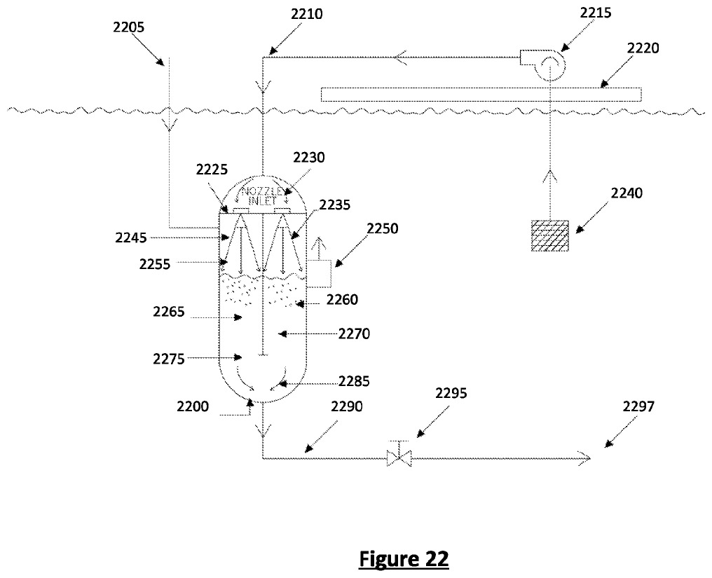

Next, the location of a multi-stage oxygenation system relative to a fish pen is described with respect to FIGS. 20 and 21. For example, FIG. 20 shows an oxygenation system according to exemplary aspects of this disclosure, which is submerged and connected to a water inlet pipe, for example. As can be appreciated, the oxygenation system may have sufficient ballast in order to remain at the desired depth and may be anchored or moored to maintain its location relative to the fish pen. The inclusion of ballast in the oxygenation system is also illustrated in FIG. 20.

FIG. 21 also shows a submerged multi-stage oxygenation system according to exemplary aspects of the present disclosure. In FIG. 21, the oxygenation system is connected to an inlet water supply line of the fish pen, and is also connected to an oxygen supply and an electrical supply in order to supply power to a pump, or pumps, of the oxygenation system. Though FIG. 21 shows that the oxygen and electrical supplies are located on the fish pen, other locations for these supplies are also possible without departing from the scope of the present disclosure. Likewise, in both FIGS. 20 and 21 the oxygenation system is shown at a depth near the bottom of the fish pen. However, the oxygenation system may be submerged at any depth without limitation. Thus the relative location of the oxygenation systems with respect to the fish pens in FIGS. 20-21, as well as the illustrated connections, are merely examples and are not limiting upon the present disclosure.

FIG. 22 shows a two-stage oxygenator 2200 with back pressure control according to an exemplary embodiment of the present disclosure. As shown in FIG. 22, the two-stage oxygenator 2200 includes an oxygen feed line 2205 that feeds oxygen to the head space zone 2245. A water pump 2215 located on a platform 2220 draws water through an inlet 2240 and provides the water via a water line feed 2210 to the flooded zone 2230 of the two-stage oxygenator 2200. The flooded zone 2230, in turn, feeds the spray nozzles 2235 which generate the water spray 2255. The water spray 2255 enters a bubble entrainment zone 2260 above a stilling zone 2270. As can be seen from the figure, the two-stage oxygenator 2200 has two gas-tight chambers separated by a baffle wall 2265. A float activated off-gas release valve 2250 is affixed to the side of the two-stage oxygenator 2200 in the vicinity of the head space zone 2245 in order to release pressure, as necessary. The two gas-tight chambers are joined by a blending zone 2285 at the end 2275 of the baffle wall 2265. A discharge line 2290 is connected to the blending zone 2285 in order to output, via a back pressure valve 2295, the treated water 2297.

The blending zone 2285 allows for water with different dissolved oxygen levels produced by the different stages, or chambers, to be mixed prior to delivery to a user area. The blending zone 2285 may have a rounded bottom to accommodate internal pressures that may exceed local hydrostatic pressures at depth. The back pressure valve 2295 may be manually or remotely actuated with a motorized assembly. For example, water depth may at one site be limited to 20 feet but performance levels representing 35 feet may be desired (performance increases with pressure). Therefore, the back pressure valve 2295 may be actuated to create a back pressure increase in the reactor of 15 feet. As can be appreciated, back pressure may also be adjusted on demand.

As can be appreciated the two-stage oxygenator 2200 of FIG. 22 may use a non-submersible pump for the water pump 2215, which can be situated on the platform 2220, which can, for example, be a barge or other above-surface structure. Use of a discharge valve allows for restricting water exiting the reactor, increasing pressure within the reactor to enhance gas diffusion. This is especially advantageous in areas where water depth is limiting, and higher gas transfer rates are desirable. Of course, this option also increases head loss across the system and thus makes the pump work harder for a target value of water flow rate. Hence the use of the float activated off-gas release valve 2250 to maintain the target water level within the reactor. Use of the non-submersible pump reduces cost and allows easier repair and maintenance. The line feeding the water 2210 to the two-stage reactor may be flexible in order to accommodate wave action. For simplicity, only a two-stage reactor is shown, but additional stages are also possible without departing from the scope of the present disclosure.

Though the descriptions herein mainly focus on oxygen saturation of water for the sake of brevity, one of ordinary skill will recognize that the described devices and methods are equally capable of super saturating water with carbon dioxide.

Obviously, numerous modifications and variations are possible in light of the above teachings. It is therefore to be understood that within the scope of the appended claims, embodiments of the present disclosure may be practiced otherwise than as specifically described herein.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A multi-stage oxygenator system, comprising:
a fluid-tight pressure vessel configured to be submerged and including a first section, a second section, and a third section;
a baffle configured to divide the second section of the pressure vessel into compartments, the compartments comprising a first compartment and a second compartment;
a water delivery mechanism configured to deliver water into the second section of the pressure vessel via the first section of the pressure vessel, the first section of the pressure vessel including an interface between the first section of the pressure vessel and the second section of the pressure vessel, the interface being configured to deliver the water to the second section of the pressure vessel to create flooded zones in each of the compartments of the second section, the flooded zones comprising a first flooded zone disposed within the first section and a second flooded zone disposed within the second section, the flooded zones being filled with the water;
a gas delivery mechanism configured to deliver a gas into the first compartment to create a first gas void in the first compartment, the gas including oxygen, the first gas void being disposed between the first section of the pressure vessel and the first flooded zone, the water jets or water droplets falling through the first gas void to a first free surface of the first flooded zone;
a gas connection through the baffle configured to allow gas to move from the first compartment to the second compartment;
a gas release device disposed on a side of the second section of the pressure vessel and configured to release gas from the second section, the gas release device being positioned to maintain the first gas void and a second gas void at predetermined volumes, the second gas void being disposed between the first section of the pressure vessel and the second flooded zone; and
a water discharge port disposed within the third section of the pressure vessel and configured to output treated water from the pressure vessel,
wherein the third section of the pressure vessel connects the compartments of the second section to allow water from the flooded zones of each of the compartments of the second section to mix to produce the treated water, and wherein the multi-stage oxygenation system is configured to be secured and stabilized at a predetermined depth.

2. The multi-stage oxygenator system of claim 1, wherein the interface between the first section and the second section of the pressure vessel includes a plate with a plurality of openings, the openings being configured to form water jets.

3. The multi-stage oxygenator system of claim 1, wherein the water delivery mechanism includes:
a pipe disposed in a center of the pressure vessel and extending through the first section, second section, and third section; and
a manifold connected to the pipe and connected to the interface between the first section and the second section of the pressure vessel,
wherein the pipe is configured to deliver the water to the manifold, and the manifold is configured to deliver the water to each of the compartments of the second section via the interface between the first section and the second section of the pressure vessel, and
the baffle is attached to the pipe and an interior wall of the pressure vessel to create the two or more first compartment and the second compartment.

4. The multi-stage oxygenator system of claim 1, wherein the first section of the pressure vessel includes a chamber configured to be flooded with water by the water delivery mechanism, and
wherein the interface between the first section and the second section of the pressure vessel includes a plate with one of:
a plurality of openings to form water jets, the water jets being configured to deliver the water to the compartments of the second section at a predetermined water pressure, or
at least one nozzle, the at least one nozzle being configured to form water droplets, the water droplets being configured to deliver the water to the compartments of the second section at the predetermined water pressure.

5. The multi-stage oxygenator system claim 1, wherein the gas release device includes one of a float valve or an off-gas vent,
the off-gas vent including a connector connected to the pressure vessel, a right-angle coupling connected to the connector, and a tube connected to the right-angle coupling, an open end of the tube defining a location of the free surfaces of the flooded zones of the compartments of the second section.

6. The multi-stage oxygenator system of claim 1, wherein the water discharge port is coupled to a pressure control valve, the pressure control valve being configured to maintain the pressure vessel at a predetermined pressure.

7. The multi-stage oxygenator system of claim 6, wherein the predetermined pressure regulates oxygen exchange from the gas to the water and facilitates nitrogen removal from the water, the predetermined pressure simulating a depth of 100 ft underwater.

8. The multi-stage oxygenator system of claim 7, wherein reactor off-gas containing oxygen and nitrogen is vented from the compartments of the second section of the pressure vessel via a gas release valve.

9. The multi-stage oxygenator system of claim 1, wherein the pressure vessel is secured and stabilized in position via at least one of a ballast and a mooring structure, and a pipe riser configured to deliver the water to the water delivery mechanism.

10. The multi-stage oxygenator system of claim 9, wherein the multi-stage oxygenator system further comprises a submersible pump attached to the pipe riser to pump water through the pipe riser to the water delivery mechanism, the submersible pump forming at least part of the ballast stabilizing the multi-stage oxygenator.

11. The multi-stage oxygenator of claim 4, wherein the water passing through the plate impacts the first free surface of the first flooded zone and a second free surface of the second flooded zone to form bubble entrainments zones in each of the compartments of the first compartment and the second compartment, and
stilling zones are disposed between the bubble entrainment zones and the third section of the pressure vessel in each of the first compartment and the second compartment such that bubbles in the water in the stilling zones coalesces and rises to a respective one of the first free surface and second free surface and a respective one of the first gas void and second gas void thereafter.

12. The multi-stage oxygenator system of claim 1, wherein the multi-stage oxygenator system further comprises:
a pump coupled to the water delivery mechanism and configured to pump the water from a water source into the water delivery mechanism; and
a screen coupled to an intake of the pump and configured to screen solids from the water,
wherein the water source is a body of water.

13. The multi-stage oxygenator system of claim 1, wherein the multi-stage oxygenator system further comprises a backflow baffle oriented perpendicular to the baffle, the backflow baffle being configured to separate downward flowing bubbles in at least one flooded zone of the flooded zones from upward flowing bubbles in the respective compartment of the at least one flooded zone, the backflow baffle being attached to an inner wall of the pressure vessel.

14. The multi-stage oxygenator system of claim 1, wherein the multi-stage oxygenator system further comprises a vent, the vent being configured to vent gas from the pressure vessel during at least one of installation, maintenance, and retrieval of the pressure vessel.

15. The multi-stage oxygenator system of claim 1, wherein the water delivery mechanism includes:
at least one distribution plate having a predetermined number of orifices distributed within one or more zones of the at least one distribution plate and no orifices in at least one remaining zone of the at least one distribution plate,
wherein the water flows through the orifices of the at least one distribution plate into the compartments of the second section,
the orifices in the at least one distribution plate are arranged in double rows to form orifice groups separated by gaps, the gaps having no orifices, and
the orifice groups are arranged to cover a predetermined amount of linear area based on hydraulic loading corresponding to a predetermined application of the multi-stage oxygenator system.

16. The multi-stage oxygenator system of claim 1, wherein the compartments of the second section of the pressure vessel further comprises at least one additional compartment, the at least one additional compartment comprising:
at least one additional flooded zone, the at least one additional flooded zone comprising at least one additional free surface;
at least one additional gas void disposed between the first section of the pressure vessel and the at least one additional flooded zone; and
at least one additional gas connection configured to allow gas to flow between adjacent compartments of the second section, wherein
the first of the at least one additional compartment is disposed adjacent to the second compartment and each subsequent compartment of the at least one additional compartment is disposed adjacent to a former compartment to form a series of compartments, each subsequent compartment being separated from the former compartment in the series by at least one additional baffle.

17. The multi-stage oxygenator system of claim 16, wherein the gas release device is configured to release gas directly from the last compartment of the series of compartments.

18. A multi-stage oxygenator system, comprising:
a fluid-tight pressure vessel configured to be submerged and including a first section, a second section, and a third section;
a baffle configured to divide the second section of the pressure vessel into compartments, the compartments comprising a first compartment and a second compartment;
a water delivery mechanism configured to deliver water into the first compartment and the second compartment of the pressure vessel via the first section of the pressure vessel, the first section of the pressure vessel including an interface between the first section of the pressure vessel and the second section of the pressure vessel, the interface being configured to deliver the water to the first compartment and the second compartment to create a first flooded zone disposed within the first section and a second flooded zone disposed within the second section, the first flooded zone and the second flooded zone being filled with the water;
a gas delivery mechanism configured to deliver a gas into the first compartment to create a first gas void in the first compartment, the gas including oxygen, the first gas void being disposed between the first section of the pressure vessel and the first flooded zone, the gas void being configured to allow water to fall through the first gas void to a first free surface of the first flooded zone;
a gas connection through the baffle configured to allow gas to move from the first compartment to the second compartment;
a gas release device disposed on a side of the second section of the pressure vessel and configured to release gas, the gas release device being positioned to maintain the first gas void and a second gas void at predetermined volumes, the second gas void being disposed between the first section of the pressure vessel and the second flooded zone; and
a water discharge port disposed within the third section of the pressure vessel and configured to output treated water from the pressure vessel,
wherein the third section of the pressure vessel connects the first compartment and the second compartment to allow water from the first flooded zone and the second flooded zone to mix to produce the treated water, and
wherein the multi-stage oxygenation system is configured to be secured and stabilized at a predetermined depth.

19. The multi-stage oxygenator system of claim 18, wherein the interface between the first section and the second section of the pressure vessel includes a plate with a plurality of openings, the openings being configured to form at least one of water jets, and water droplets.

20. A multi-stage oxygenator system, comprising:
a fluid-tight pressure vessel configured to be submerged and including a first section, a second section, and a third section;
a baffle configured to divide the second section of the pressure vessel into compartments, the compartments comprising a first compartment and a second compartment;
a water delivery mechanism configured to deliver water into the second section of the pressure vessel via the first section of the pressure vessel, the first section of the pressure vessel including an interface between the first section of the pressure vessel and the second section of the pressure vessel, the interface being configured to deliver the water to the second section of the pressure vessel to create flooded zones in each of the compartments of the second section, the flooded zones comprising a first flooded zone disposed within the first section and a second flooded zone disposed within the second section, the flooded zones being filled with the water;
a gas delivery mechanism configured to deliver a gas into the first compartment to create a first gas void in the first compartment, the gas including oxygen, the first gas void being disposed between the first section of the pressure vessel and the first flooded zone, the water falling through the first gas void to a first free surface of the first flooded zone;
a gas connection through the baffle configured to allow gas to move from the first compartment to the second compartment;
a gas release device disposed on a side of the second section of the pressure vessel and configured to release gas from the second section, the gas release device being positioned to maintain the first gas void and a second gas void at predetermined volumes, the second gas void being disposed between the first section of the pressure vessel and the second flooded zone; and
a water discharge port disposed within the third section of the pressure vessel and configured to output treated water from the pressure vessel,
wherein the third section of the pressure vessel connects the compartments of the second section to allow water from the first flooded zone and the second flooded zone to mix to produce the treated water,
wherein the multi-stage oxygenation system is configured to be secured and stabilized at a predetermined depth, and
wherein the first section of the pressure vessel includes a chamber configured to be flooded with water by the water delivery mechanism, and
wherein the interface between the first section and the second section of the pressure vessel includes a plate with one of:
a plurality of openings to form water jets, the water jets being configured to deliver the water to the compartments of the second section at a predetermined water pressure, or
at least one nozzle, the at least one nozzle being configured to form water droplets, the water droplets being configured to deliver the water to the compartments of the second section at the predetermined water pressure.
